(19) United States
(12) Patent Application Publication
(10) Pub. No.: US 2024/0053723 A1
(43) Pub. Date: Feb. 15, 2024

(54) OBSERVATION DEVICE AND OBSERVATION METHOD

(71) Applicant: FANUC CORPORATION, Yamanashi (JP)

(72) Inventor: Sichen LIU, Yamanashi-ken (JP)

(21) Appl. No.: 18/260,153

(22) PCT Filed: Jan. 5, 2022
(86) PCT No.: PCT/JP2022/000062

§ 371 Date: Jun. 30, 2023

(30) Foreign Application Priority Data
Jan. 7, 2021 (JP) 2021-001389

(51) Int. Cl. G05B 19/402; G01M 1/16; B23Q 17/22

(52) U.S. Cl. CPC G05B 19/402; G01M 1/16; B23Q 17/22; G05B 2219/39101

(57) ABSTRACT

This observation device includes a command output unit that rotates a rotating body and stops a moving body; a first acquisition unit that acquires the rotation angle of the rotating body; a second acquisition unit that acquires the positional deviation of the moving body; and a display control unit that displays, on a display unit, the current rotation angle and a graph showing the correspondence relationship between the rotation angle and the positional deviation, said relationship being corrected on the basis of a first angle difference between a prescribed operation position and an operation position.

### TECHNICAL FIELD

The present invention relates to an observation device and an observation method configured to observe a state of balance of a rotating body of a machine tool.

### BACKGROUND ART

In JP H03-251066 A, a field balancer is disclosed. The field balancer is a device for observing a state of balance (balance state) in rotation of a rotationally driven observation target. The observation target, for example, is a motor (a motor shaft).

### SUMMARY OF THE INVENTION

A machine tool is equipped with a rotating body that is rotationally driven. The rotating body, for example, is a spindle (main shaft) or a face plate. An operator of the machine tool installs the field balancer on the machine tool in order to measure a balance state of the rotating body. Based on the balance state of the rotating body that has been measured, the operator can perform an operation in order to correct the balance state of the rotating body.

However, the accuracy in observing the balance state of the rotating body by a field balancer depends on the manner in which the field balancer is installed, and the position where the field balancer is installed. Accordingly, it is difficult for anyone to investigate the balance state of a rotating body with stable and consistent accuracy. Further, it is also difficult for anyone to execute a balance correcting operation with stable and consistent accuracy.

The present invention has the object of solving the aforementioned problems.

A first aspect of the present invention is characterized by an observation device configured to observe a balance state of a rotating body of a machine tool, the machine tool including the rotating body, a detector configured to detect an angle of rotation of the rotating body, and a moving body configured to move along a movement axis perpendicular to a central line of rotation of the rotating body, the observation device including a command output unit configured to issue a command to the machine tool so as to stop the moving body at a predetermined position while the rotating body is made to rotate, a first acquisition unit configured to acquire the angle of rotation, based on a detection signal of the detector, a second acquisition unit configured to acquire a positional deviation of the moving body in a direction of the movement axis, a first storage control unit configured to, at a time when an operating position at which a weight for balance adjustment is actually attached to or detached from the rotating body is changed from a predetermined position that is determined beforehand as an operating position at which an operator or a robot attaches or detaches the weight to or from the rotating body, cause a storage unit to store a first angular difference in a direction of rotation of the rotating body between a predetermined operating position and a changed operating position, a second storage control unit configured to cause the storage unit to store a plurality of the angles of rotation and the positional deviation corresponding to each of the plurality of the angles of rotation, in association with each other, a first compensation unit configured to compensate the angle of rotation associated with the positional deviation or a current angle of rotation of the rotating body, based on the first angular difference, and a display control unit configured to cause a display unit to display, based on a compensation result of the first compensation unit, a graph showing a corresponding relationship between the plurality of the angles of rotation and the positional deviations that are stored in association with the plurality of the angles of rotation, and configured to further cause the current angle of rotation of the rotating body to be displayed on the graph.

A second aspect of the present invention is characterized by an observation method for observing a balance state of a rotating body of a machine tool, the machine tool including the rotating body, a detector configured to detect an angle of rotation of the rotating body, and a moving body configured to move along a movement axis perpendicular to a central line of rotation of the rotating body, the observation method including a command output step of issuing a command to the machine tool so as to stop the moving body at a predetermined position while the rotating body is made to rotate, a first acquisition step of acquiring the angle of rotation, based on a detection signal of the detector, a second acquisition step of acquiring a positional deviation of the moving body in a direction of the movement axis, a first storage step of, at a time when an operating position at which a weight for balance adjustment is actually attached to or detached from the rotating body is changed from a predetermined position that is determined beforehand as an operating position at which an operator or a robot attaches or detaches the weight to or from the rotating body, storing in a storage unit a first angular difference in a direction of rotation of the rotating body between the predetermined operating position and a changed operating position, a second storage step of storing in the storage unit a plurality of the angles of rotation and the positional deviation corresponding to each of the plurality of the angles of rotation, in association with each other, a first compensation step of compensating the angle of rotation associated with the positional deviation or a current angle of rotation of the rotating body, based on the first angular difference, and a display control step of causing a display unit to display, based on a compensation result performed in the first compensation step, a graph showing a corresponding relationship between the plurality of the angles of rotation and the positional deviations that are stored in association with the plurality of the angles of rotation, and further causing the current angle of rotation of the rotating body to be displayed on the graph.

According to the aspects of the present invention, it is possible to observe a balance state of a rotating body of a machine tool, without using a field balancer. Further, it is possible for the balance correcting operation of the rotating body to be easily carried out by an operator.

### BRIEF DESCRIPTION OF DRAWINGS

FIG. 1 is a configuration diagram of an observation system according to an embodiment;

FIG. 2 is a simplified configuration diagram of a rotating body and a main shaft motor according to the embodiment;

FIG. 3A is a first schematic diagram for describing the detection of an angle of rotation by a detector;

FIG. 3B is a second schematic diagram for describing the detection of the angle of rotation by the detector;

FIG. 4 is a configuration diagram of the observation device according to the embodiment;

FIG. 5 is a schematic diagram illustrating an angular difference that is stored in a storage unit;

FIG. 6 is a graph illustrating the phase of an angle of rotation of the rotating body acquired by a first acquisition unit;

FIG. 7 is a graph illustrating the phase of a positional deviation of a moving body acquired by a second acquisition unit;

FIG. 8 is a graph illustrating a corresponding relationship between a plurality of the angles of rotation acquired by the first acquisition unit, and the positional deviations corresponding respectively to the plurality of the angles of rotation acquired by the first acquisition unit;

FIG. 9 is a diagram illustrating the graph of FIG. 8 together with an auxiliary line showing a current angle of rotation compensated by a first compensation unit;

FIG. 10 is a flowchart illustrating a process flow of an observation method according to the embodiment;

FIG. 11A is a schematic diagram for providing a description concerning a balance correcting operation for a case in which a weight is attached or detached at a predetermined operating position;

FIG. 11B is a diagram illustrating a graph and an auxiliary line displayed by the display control unit in the case of FIG. 11A;

FIG. 12A is a schematic diagram for providing a description concerning the balance correcting operation for a case in which a position for attaching or detaching the weight is changed from the predetermined operating position;

FIG. 12B is a diagram illustrating a graph and an auxiliary line displayed by the display control unit in the case of FIG. 12A;

FIG. 13 is a schematic diagram illustrating a second angular difference that is stored in the storage unit;

FIG. 14 is a configuration diagram of the observation device according to an Exemplary Modification 1;

FIG. 15A is a schematic diagram for providing a description concerning the balance correcting operation for a case in which a first detector is not installed in a predetermined installation position, and further, a position for attaching or detaching a weight is changed from a predetermined operating position;

FIG. 15B is a diagram illustrating a graph and an auxiliary line displayed by the display control unit in the case of FIG. 15A;

FIG. 16 is a schematic diagram for providing a supplementary description concerning an application of the Exemplary Modification 1;

FIG. 17 is a configuration diagram of the observation device according to an Exemplary Modification 2;

FIG. 18 is a graph obtained by reversing the polarity in the graph of FIG. 9;

FIG. 19 is a configuration diagram of the observation device according to an Exemplary Modification 4;

FIG. 20 is a graph obtained by reversing the orientation concerning a magnitude in a deviation axis of the graph of FIG. 9; and

FIG. 21 is a graph illustrating a corresponding relationship between a plurality of the angles of rotation, and the positional deviations corresponding respectively to the plurality of the angles of rotation.

### DETAILED DESCRIPTION OF THE INVENTION

### Embodiments

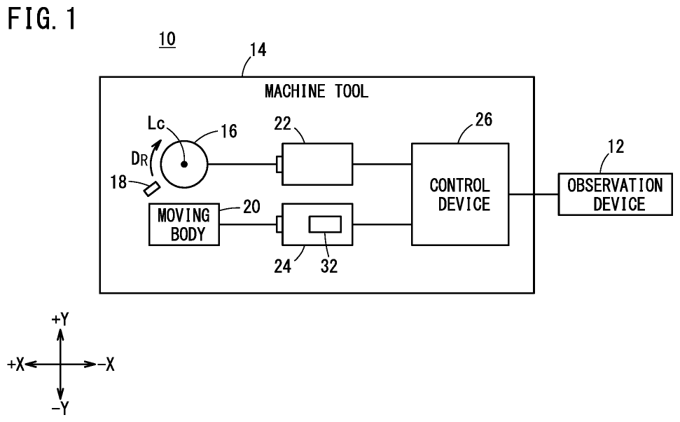

FIG. 1 is a configuration diagram of an observation system 10 according to an embodiment.

The observation system 10 includes an observation device 12 and a machine tool 14. Hereinafter, the machine tool 14 and the observation device 12 will be described sequentially in this order.

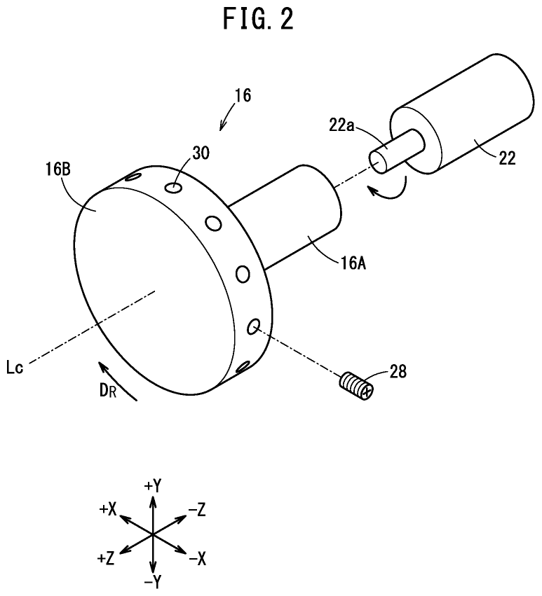

FIG. 1 illustrates not only the observation system 10, but also an X-axis and a Y-axis. Further, FIG. 2, which will be referred to later, also illustrates a Z-axis. The X-axis, the Y-axis, and the Z-axis are directional axes that are perpendicular to each other. The X-axis and the Z-axis are parallel to the horizontal plane. The Y-axis is parallel to the direction of gravity. Concerning the directional axes of each of the X-axis, the Y-axis, and the Z-axis, one direction along the directional axis is designated by a “+” sign, and the other direction is designated by a “−” sign. For example, a direction toward one side along the X-axis is represented as a “+X direction”. Further, a direction opposite to the +X direction is expressed as a “−X direction”.

The machine tool 14 is an industrial machine that produces a product by carrying out machining of a workpiece (an object to be machined). The machine tool 14 is equipped with a rotating body 16, a first detector 18, a moving body 20, a main shaft motor 22, a feeding motor 24, and a control device 26. The rotating body 16 is a member that undergoes rotation. The first detector 18 is a sensor for detecting an angle of rotation RA of the rotating body 16. The moving body 20 is a member that moves along a predetermined movement axis (movement axis). The main shaft motor 22 is an actuator (a motor) that causes the rotating body 16 to rotate. The feeding motor 24 is an actuator (a motor) that causes the moving body 20 to move. The control device 26 is a device for the purpose of controlling the main shaft motor 22 and the feeding motor 24. The machine tool 14, for example, is a lathing machine. However, the machine tool 14 according to the present embodiment is not limited to being a lathing machine.

FIG. 2 is a simplified configuration diagram of the rotating body 16 and the main shaft motor 22 according to the embodiment.

The rotating body 16 rotates centrally about a central line of rotation L_{c}. The central line of rotation L_{c} is an imaginary straight line along the Z-axis direction. An arrow (D_{R}) in FIG. 2 indicates the direction of rotation of the rotating body 16. The rotating body 16 according to the present embodiment includes a main shaft (spindle) portion 16A, and a rotating portion 16B. The main shaft portion 16A undergoes rotation in accordance with the main shaft motor 22 being driven. The rotating portion 16B is a disk-shaped member. The rotating portion 16B is supported by the main shaft portion 16A. The rotating portion 16B is capable of rotating integrally together with the main shaft portion 16A.

The main shaft portion 16A is electrically driven. More specifically, the main shaft portion 16A undergoes rotation in accordance with the electric main shaft motor 22 being driven. However, the method of driving the main shaft portion 16A is not limited to being an electric method. For example, the method of driving the main shaft portion 16A may be an air-based method. In the case of an air-based method, the main shaft portion 16A is rotationally driven in accordance with supplied air (an air turbine). In this case, the main shaft motor 22 may be omitted from the configuration of the machine tool 14.

The main shaft portion 16A includes an end portion in the +Z direction. Such an end portion is connected to the rotating portion 16B (refer to FIG. 2). The rotating portion 16B, for example, is a face plate or a chuck portion that serves to support the workpiece.

The rotating portion 16B includes a plurality of weight attachment and detachment portions 30. The plurality of the weight attachment and detachment portions 30 are arranged on a side surface (an outer peripheral surface) of the rotating portion 16B. In this instance, the side surface of the rotating portion 16B is a surface of the rotating portion 16B (refer to FIG. 2) that faces toward the X-axis direction or the Y-axis direction. Each of the plurality of the weight attachment and detachment portions 30 detachably retains a balance adjustment weight (weight for balance adjustment) 28. By attaching and detaching the weight 28 to and from the rotating portion 16B, the position of the center of gravity of the rotating portion 16B changes. Consequently, a balance state (a state of balance) of the rotating portion 16B is corrected. Moreover, it should be noted that the plurality of the weight attachment and detachment portions 30 may be arranged on a front surface of the rotating portion 16B, or alternatively, on a rear surface of the rotating portion 16B. In this instance, the front surface of the rotating portion 16B is a surface that faces toward the +Z direction. The rear surface of the rotating portion 16B is a surface that faces toward the −Z direction. When the plurality of the weight attachment and detachment portions 30 are arranged on the front surface of the rotating portion 16B, the weight 28 is attached to and detached from the front surface of the rotating portion 16B. Further, as for the plurality of the weight attachment and detachment portions 30, in the case that the plurality of the weight attachment and detachment portions 30 are arranged on the rear surface of the rotating portion 16B, the weight 28 is attached to and detached from the rear surface of the rotating portion 16B.

The weight 28, for example, is a screw. In this case, each of the plurality of the weight attachment and detachment portions 30 is a screw hole. In this case, the weight 28 is inserted into the weight attachment and detachment portion 30. Consequently, the weight 28 is attached to the rotating portion 16B. Further, the weight 28 is unscrewed from the weight attachment and detachment portion 30. Consequently, the weight 28 is detached from the rotating portion 16B.

The weights 28 are attached to and detached from the rotating portion 16B (the plurality of the weight attachment and detachment portions 30) by an operator or a robot. In this instance, according to the present embodiment, an operating position where the operation (attachment or detachment operation) of attaching or detaching the weight 28 to or from the weight attachment and detachment portion 30 is performed is predetermined. In the following description, the predetermined operating position is also referred to as a predetermined operating position Pₒₚₑ. The predetermined operating position Pₒₚₑ is a position on a machine coordinate system of the machine tool 14. For example, even if the rotating portion 16B rotates along a direction of rotation D_{R}, the predetermined operating position Pₒₚₑ does not move. However, in the case that the rotating portion 16B moves on a plane parallel to the XY plane, the predetermined operating position Pₒₚₑ moves together with the rotating portion 16B. The attachment or detachment operation is performed in a state in which the position of the weight attachment and detachment portion 30 is aligned with the predetermined operating position Pₒₚₑ in the direction of rotation D_{R}. By determining beforehand the predetermined operating position Pₒₚₑ, it is possible to unify the procedure of attaching or detaching the weight 28.

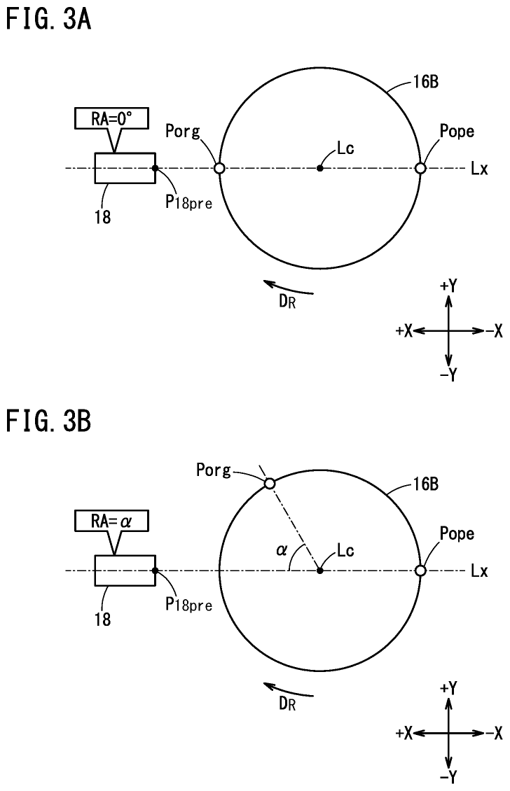

In FIG. 3A and FIG. 3B, the predetermined operating position Pₒₚₑ according to the present embodiment is illustrated. The predetermined operating position Pₒₚₑ according to the present embodiment is a position that is at an angle of 180 degrees from an installation position P₁₈ₚᵣₑ of the first detector 18 along the direction of rotation D_{R}. However, the predetermined operating position Pₒₚₑ may be the same position as the first detector 18 in the direction of rotation D_{R}.

The main shaft motor 22 that causes the main shaft portion 16A to rotate, for example, is a spindle motor. The main shaft motor 22 includes a shaft 22a. The shaft 22a is connected to the main shaft portion 16A. The main shaft motor 22 is capable of causing the main shaft portion 16A to be rotated along the direction of rotation D_{R} in accordance with the rotational driving of the shaft 22a.

The first detector 18, which detects the angle of rotation RA of the rotating body 16, for example, is a rotary encoder. The first detector 18 is installed at a position that differs from the rotating body 16 (the rotating portion 16B) on a plane that is parallel to the XY plane.

FIG. 3A is a first schematic diagram for describing the detection of an angle of rotation RA by the first detector 18. FIG. 3B is a second schematic diagram for describing the detection of the angle of rotation RA by the first detector 18.

The rotating portion 16B (the rotating body 16) has an origin point P_{org} (refer to FIG. 3A). The origin point P_{org} is a reference point (a point indicating zero degrees) of the angle of rotation RA. When the rotating portion 16B rotates, the origin point P_{org} moves along the direction of rotation D_{R}. By the rotating portion 16B being rotated, the origin point P_{org} arrives at the installation position P₁₈ₚᵣₑ of the first detector 18 in the direction of rotation D_{R} (refer to FIG. 3A). When the origin point P_{org} arrives at the installation position P₁₈ₚᵣₑ, the first detector 18 outputs to the control device 26 a detection signal which indicates zero degrees as being the angle of rotation RA. Further, in the case that the origin point P_{org} is moved to a position that is a degrees ahead of the installation position P₁₈ₚᵣₑ along the direction of rotation D_{R}, the first detector 18 outputs to the control device 26 a detection signal which indicates α degrees as being the angle of rotation RA (refer to FIG. 3B).

The installation position P₁₈ₚᵣₑ of the first detector 18 is a position that is determined beforehand. The installation position P₁₈ₚᵣₑ according to the present embodiment is a position more in the +X direction than the rotating portion 16B. Further, the installation position P₁₈ₚᵣₑ according to the present embodiment lies on a line Lₓ. The line Lₓ is an imaginary straight line that is parallel to the X-axis and passes through the central line of rotation L_{c}. In this case, the installation position P₁₈ₚᵣₑ and the aforementioned predetermined operating position Pₒₚₑ sandwich the central line of rotation L_{c} therebetween on the line Lₓ.

The movement axis of the moving body 20 is an axis along a direction perpendicular to the central line of rotation L_{c}. The moving body 20 is connected to the shaft of the feeding motor 24 via a ball screw and a nut. The ball screw is installed parallel to the movement axis of the moving body 20. The ball screw rotates together with the shaft of the feeding motor 24. The nut is screw-engaged onto the ball screw. The moving body 20 is connected to the nut. Consequently, the moving body 20 is capable of moving along the movement axis in accordance with the driving of the feeding motor 24. It should be noted that illustration of the ball screw and the nut is omitted.

The movement axis according to the present embodiment is parallel to the X-axis. Therefore, the moving body 20 moves in the +X direction or in the −X direction. The amount of movement of the moving body 20 correlates with the amount of rotation of the shaft of the feeding motor 24.

The moving body 20 is connected to (supported on) the main shaft portion 16A. Consequently, the rotating body 16 moves together with the moving body 20 along the +X direction or the −X direction.

The feeding motor 24 that causes the moving body 20 to move, for example, is a servo motor. A second detector 32 is provided in the feeding motor 24. The second detector 32 is a sensor for detecting an angle of rotation of the feeding motor 24. The second detector 32, for example, is a rotary encoder.

The control device 26 is an electronic device (a computer) including, for example, a processor, a memory, and an amplifier. The control device 26 serves to numerically control the main shaft motor 22 and the feeding motor 24. The control device 26 acquires a detection signal of the first detector 18. In accordance therewith, the control device 26 acquires the angle of rotation RA of the main shaft motor 22. Further, the control device 26 acquires a detection signal of the second detector 32. In accordance therewith, the control device 26 acquires the angle of rotation of the feeding motor 24. Furthermore, the control device 26 calculates a positional deviation PD of the moving body 20 in the X-axis direction, as will be described below.

The positional deviation PD is the deviation (difference) between an angle of rotation commanded to the feeding motor 24 by the control device 26, and an actual angle of rotation of the feeding motor 24 in accordance with such a command. In this instance, in the case of the present embodiment, the amount of rotation of the feeding motor 24 and the amount of movement of the moving body 20 in the X-axis direction are correlated with each other. Accordingly, the positional deviation PD substantially indicates the difference between the commanded position and the actual position of the moving body 20 in the X-axis direction. By further controlling the feeding motor 24 in a manner so that the positional deviation PD comes into close proximity to zero, the control device 26 is capable of accurately controlling the position of the moving body 20 in the X-axis direction.

An exemplary configuration of the machine tool 14 has been described above. Subsequently, the observation device 12 according to the present embodiment will be described. Moreover, in the following description, unless otherwise specified in particular, the “rotating body 16” indicates the rotating portion 16B from among the main shaft portion 16A and the rotating portion 16B.

The observation device 12 is an electronic device for the purpose of observing changes in the balance state of the rotating body 16. Although the details thereof will be described later, the observation device 12 acquires the angle of rotation RA of the rotating body 16, and the positional deviation PD of the moving body 20, from the machine tool 14. Further, the observation device 12 associates the angle of rotation RA and the positional deviation PD with each other. In particular, in the case that the operating position for performing an attachment or detachment operation is changed, the observation device 12 according to the present embodiment compensates the angle of rotation RA in accordance with such a change. Consequently, in the observation device 12, it becomes easy for the balance correcting operation of the rotating body 16 to be carried out by the operator. Further, the accuracy of the balance correction is improved.

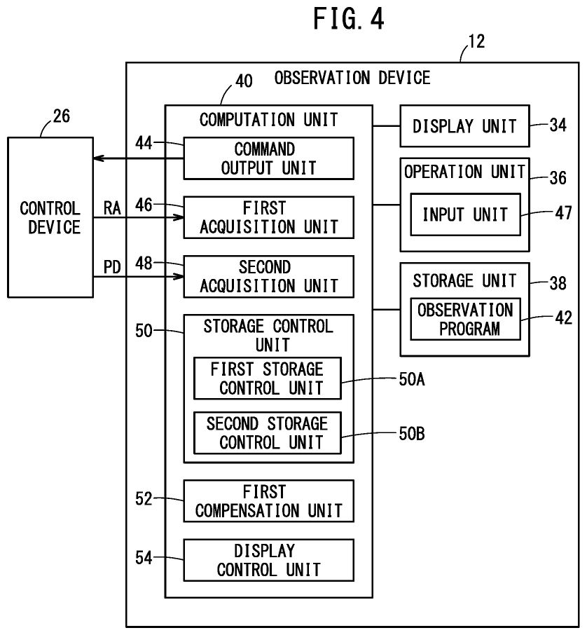

FIG. 4 is a configuration diagram of the observation device 12 according to the embodiment.

The observation device 12 is equipped with a display unit 34, an operation unit 36, a storage unit 38, and a computation unit 40.

The display unit 34, for example, is a device having a liquid crystal screen. The display unit 34 serves to display information. Moreover, the screen of the display unit 34 according to the present embodiment is a liquid crystal screen. However, the screen of the display unit 34 is not limited to being a liquid crystal screen. For example, the display unit 34 may be an organic EL (OEL: Organic Electro-Luminescence) screen.

The operation unit 36 includes, for example, a keyboard, a mouse, and a touch panel. The touch panel is installed, for example, on the screen of the display unit 34. The operation unit 36 receives information that is input by the operator. In accordance with this feature, the operator is capable of appropriately inputting his or her own instructions to the observation device 12.

The operation unit 36 includes an input unit 47. The input unit 47 receives an operation of the operation unit 36 to change the operating position for attaching and detaching the weight 28, from the predetermined operating position Pₒₚₑ to another position. The operator can optionally change the operating position for attaching and detaching the weight 28, via the input unit 47. For example, there is a case where the operator may wish to place some other type of member in close proximity to the predetermined operating position Pₒₚₑ. In this case, the operator changes the operating position, in a manner so that the other member does not hinder the attachment or detachment operation of attaching or detaching the weight 28.

In the description that follows, the changed operating position for the weight 28 is also referred to as an operating position P′ₒₚₑ. The operating position P′ₒₚₑ is a position on the machine coordinate system of the machine tool 14.

The storage unit 38 includes a memory. For example, the storage unit 38 includes a memory such as a RAM (Random Access Memory) or a ROM (Read Only Memory). The storage unit 38 serves to store information.

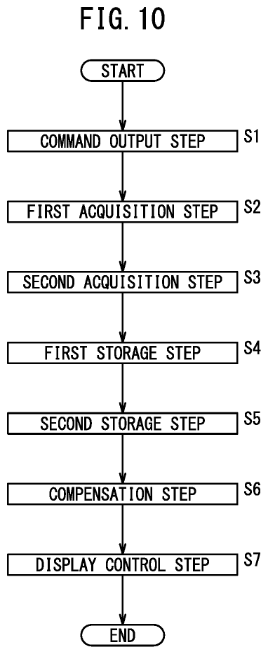

The storage unit 38 stores an observation program 42 (refer to FIG. 4). The observation program 42 is a program in order to cause the observation device 12 to execute the observation method according to the present embodiment. The observation method will be described later (see FIG. 10).

Further, as will be described next, the storage unit 38 also stores a first angular difference AD₁. The first angular difference AD₁ is an angular difference in the direction of rotation D_{R} between the predetermined operating position Pₒₚₑ and the actual operating position P′ₒₚₑ. The first angular difference AD₁ is input to the observation device 12 via the operation unit 36, for example, by the operator.

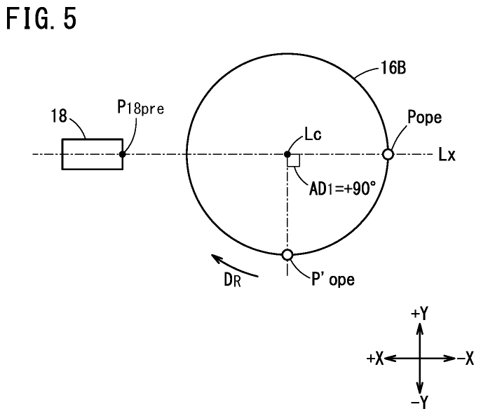

FIG. 5 is a schematic diagram illustrating a first angular difference AD₁ that is stored in the storage unit 38.

Hereinafter, a specific example of the first angular difference AD₁ will be described. The operating position P′ₒₚₑ shown in FIG. 5 is a position that is +90 degrees along the direction of rotation D_{R} from the predetermined operating position Pₒₚₑ. In this case, the first angular difference AD₁ is an angle of “90 degrees”. It should be noted that the first angle difference AD₁=90 degrees is a specific exemplification thereof. Accordingly, the first angular difference AD₁ is not limited to being an angle of 90 degrees.

The storage unit 38 further stores the plurality of the angles of rotation RA and the positional deviations PD corresponding respectively to the plurality of the angles of rotation RA. The association between the plurality of the angles of rotation RA and the plurality of the positional deviations PD will be described later.

The computation unit 40 includes a processor. The computation unit 40 includes a CPU (Central Processing Unit) and a GPU (Graphics Processing Unit). The computation unit 40 is equipped with a command output unit 44, a first acquisition unit 46, a second acquisition unit 48, a storage control unit 50, a display control unit 54, and a first compensation unit 52. The command output unit 44 issues a command to the machine tool 14 in order to appropriately perform the observation. The first acquisition unit 46 acquires the angle of rotation RA. The second acquisition unit 48 acquires the positional deviation PD. The storage control unit 50 causes the storage unit 38 to store information as appropriate. The display control unit 54 causes the display unit 34 to display the corresponding relationship between the angle of rotation RA and the positional deviation PD, and the current angle of rotation RA. The first compensation unit 52 compensates the current angle of rotation RA displayed on the display unit 34, on the basis of the first angular difference AD₁. The command output unit 44, the first acquisition unit 46, the second acquisition unit 48, the storage control unit 50, the display control unit 54, and the first compensation unit 52 are realized by the observation program 42 being executed by the computation unit 40.

The command output unit 44 issues a command to the machine tool 14. Such a command includes content to cause the rotating body 16 to rotate, and content to cause the moving body 20 to be stopped at a predetermined position in the X-axis direction. The command output unit 44, for example, issues a request to the control device 26. In accordance with the request that has been input, the control device 26 controls the main shaft motor 22 and the feeding motor 24.

When the rotating body 16 rotates based on the command from the command output unit 44, vibrations occur which are caused by the rotation of the rotating body 16. These vibrations are transmitted from the rotating body 16 to the moving body 20. As a result, the aforementioned positional deviation PD occurs.

Further, when the moving body 20 is stopped based on the command from the command output unit 44, vibrations of the moving body 20 caused by factors other than the rotation of the rotating body 16 are suppressed. In other words, the command output unit 44 is capable of easily bringing about a situation in which the positional deviation PD caused by the rotation of the rotating body 16 can be easily observed.

The first acquisition unit 46 acquires the plurality of the angles of rotation RA, based on the detection signal of the first detector 18. The first acquisition unit 46, for example, acquires from the control device 26 the angle of rotation RA that was calculated by the control device 26. However, the first acquisition unit 46 may acquire the detection signal from the control device 26 or the first detector 18. In that case, the first acquisition unit 46 may calculate the angle of rotation RA, based on the acquired detection signal.

Preferably, an acquisition cycle of the plurality of the angles of rotation RA by the first acquisition unit 46 should be as short as possible. For example, between an acquisition cycle in which the angles of rotation RA are acquired in units of 1 degree (0 degrees, 1 degree, 2 degrees, . . . , 359 degrees) and an acquisition cycle in which the angles of rotation RA are acquired in units of 0.1 degree (0.0 degrees, 0.1 degrees, 0.2 degrees, . . . , 359.9 degrees), the latter acquisition cycle is preferable. In the case that the acquisition cycle of the angles of rotation RA is short, the balance state of the rotating body 16 can be accurately observed. However, the acquisition period of the angles of rotation RA is limited in accordance with the detection period of the first detector 18 and the resolution of the first detector 18.

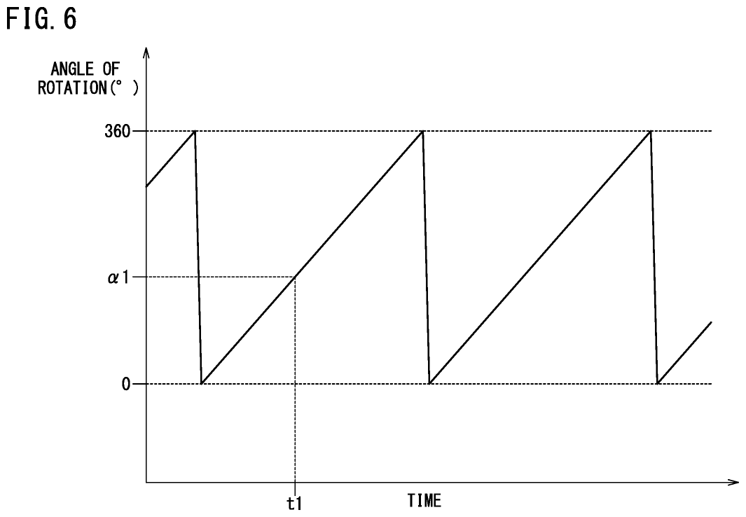

FIG. 6 is a graph illustrating the phase of the angle of rotation RA of the rotating body 16 acquired by the first acquisition unit 46.

The graph of FIG. 6 includes a vertical axis representing the angle of rotation RA and a horizontal axis representing time. The graph in FIG. 6 indicates a plurality of the angles of rotation RA acquired along a time series. For example, the angle of rotation RA of the rotating body 16 at a point in time t1 is the angle “α1”. The graph in FIG. 6 can be created based on the plurality of the angles of rotation RA that are acquired by the first acquisition unit 46. The range of the vertical axis in FIG. 6 is 0 degrees to 360 degrees. The range of the vertical axis in FIG. 6 is not limited to being 0 degrees to 360 degrees. For example, the vertical axis in FIG. 6 may include an angle of rotation RA of greater than or equal to 361 degrees. A vertical axis containing an angle of rotation RA of greater than or equal to 361 degrees is used, for example, in the case that the first detector 18 is capable of detecting angles of rotation RA of greater than or equal to 361 degrees.

The second acquisition unit 48 acquires the positional deviation PD. The second acquisition unit 48, for example, acquires from the control device 26 the positional deviation PD that was calculated by the control device 26. However, the second acquisition unit 48 may acquire a control command for the feeding motor 24, and the detection signal of the second detector 32. In that case, the second acquisition unit 48 may calculate the positional deviation PD based on the acquired control command, and the detection signal.

It is preferable that the acquisition cycle of the plurality of the positional deviations PD by the second acquisition unit 48 be synchronized with the acquisition cycle of the plurality of the angles of rotation RA by the first acquisition unit 46. However, the acquisition cycle of the plurality of the positional deviations PD by the second acquisition unit 48 need not necessarily be synchronized with the acquisition cycle of the plurality of the angles of rotation RA by the first acquisition unit 46.

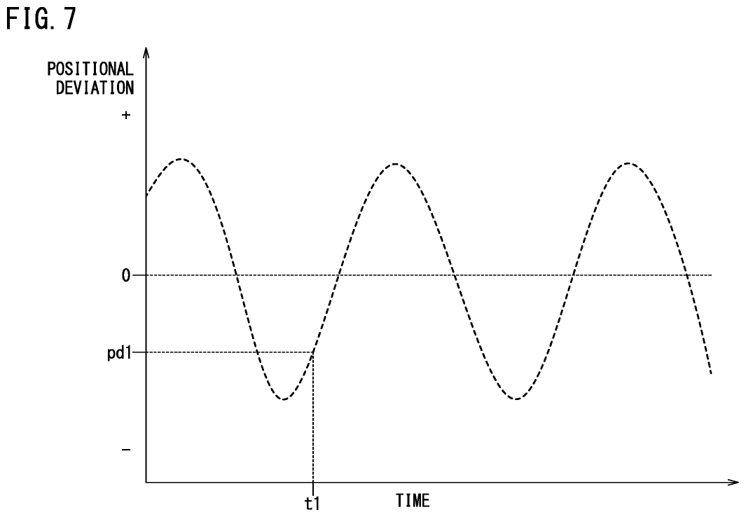

FIG. 7 is a graph illustrating the phase of the positional deviation PD of the moving body 20 acquired by the second acquisition unit 48.

The graph of FIG. 7 includes a vertical axis representing the positional deviation PD, and a horizontal axis representing time. The graph in FIG. 7 shows a plurality of the positional deviations PD acquired along a time series. For example, the positional deviation PD at the point in time t1 is pd1. The point in time t1 in FIG. 7 and the point in time t1 in FIG. 6 are the same time. The graph in FIG. 7 can be created based on the acquisition result of a plurality of the positional deviations PD by the second acquisition unit 48.

The storage control unit 50 includes a first storage control unit 50A and a second storage control unit 50B (refer to FIG. 4). The first storage control unit 50A causes the first angular difference AD₁ to be stored in the storage unit 38. For example, the first storage control unit 50A causes the first angular difference AD₁, which is input by the operator via the input unit 47, to be stored in the storage unit 38. The second storage control unit 50B causes the plurality of the angles of rotation RA and the positional deviations PD to be stored in association with each other in the storage unit 38.

The second storage control unit 50B associates the plurality of the angles of rotation RA (refer to FIG. 6) and the plurality of the positional deviations PD (refer to FIG. 7) with each other on the time axis. For example, the second storage control unit 50B associates an angle of rotation α1 acquired at the point in time t1 with a positional deviation pd1 also acquired at the point in time t1 (refer to FIG. 6 and FIG. 7). Further, the second storage control unit 50B causes the angles of rotation RA and the positional deviations PD that are associated with each other to be stored in the storage unit 38. The positional deviation pd1 indicates a balance state of the rotating body 16 in the case that the angle of rotation RA=α1.

Moreover, in the present embodiment, there is a case where the acquisition cycle of the first acquisition unit 46 and the acquisition cycle of the second acquisition unit 48 may not be synchronized. In that case, there is a possibility that an angle of rotation RA and a positional deviation PD that are acquired at the same time do not exist. In that case, in the second storage control unit 50B, the angle of rotation RA and the positional deviation PD that are acquired in close proximity to each other on the time axis may be associated with each other. Further, using linear interpolation (straight-line interpolation), the second storage control unit 50B may interpolate (estimate) the positional deviation PD that is associated with the point in time at which the angle of rotation RA is acquired.

Further, a difference in time exists from when the balance state of the rotating body 16 changes due to the vibration of the rotating body 16, to when such a vibration is transmitted to the moving body 20. Accordingly, the positional deviation PD representing the balance state of the rotating body 16 at a certain angle of rotation RA may be detected after such an angle of rotation RA has been detected. Based on the aforementioned factor, it is preferable that the association between the angle of rotation RA and the positional deviation PD be carried out in consideration of the above-described time difference. However, in order to simplify the description insofar as possible, in the present embodiment, such a time difference will be ignored.

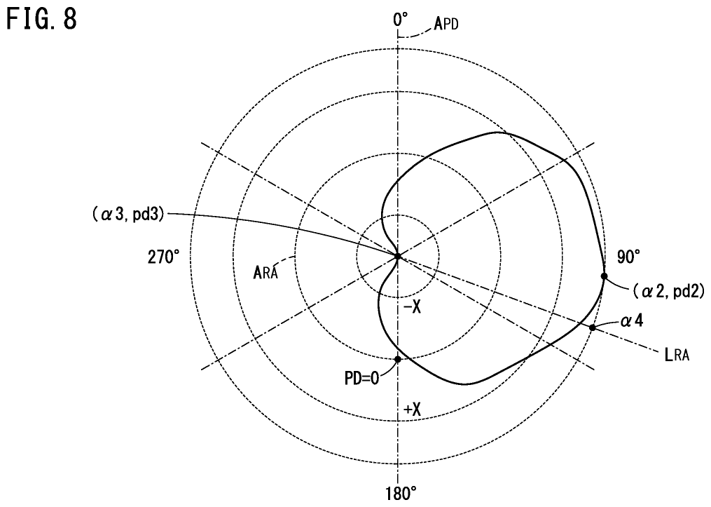

FIG. 8 is a graph illustrating a corresponding relationship between a plurality of the angles of rotation RA acquired by the first acquisition unit 46, and the positional deviations PD corresponding respectively to the plurality of the angles of rotation RA acquired by the first acquisition unit 46.

The graph of FIG. 8 includes an angular axial line (angular axis) A_{RA}, and a deviation axial line (deviation axis) A_{PD}. The angular axis A_{RA} represents, on a circle, a magnitude of the angle of rotation RA in the case that the positional deviation PD is zero. The deviation axis A_{PD} represents, on a normal line of the circle, a magnitude of the positional deviation PD. The graph in FIG. 8 can be created based on the results of associating the plurality of the angles of rotation RA with the plurality of the positional deviations PD.

The displayed range of the angles of rotation RA included on the angular axis A_{RA} is 0 to 360 degrees. More specifically, the displayed range of the angles of rotation RA included on the angular axis A_{RA} corresponds to one rotation of the rotating body 16. The graph of FIG. 8 includes a plurality of the angular axes A_{RA} (circles) with diameters that differ from each other. However, the number of the angular axes A_{RA} may also be one.

An intersection of one of the angular axes A_{RA} (a reference circle) and the deviation axis A_{PD} indicates a reference point (PD=0) of the positional deviation PD. A positional deviation PD in the +X direction is plotted outside of the reference circle. The positional deviation PD in the +X direction becomes greater in the +X direction as it is plotted farther away from the reference circle. A positional deviation PD in the −X direction is plotted inside of the reference circle. The positional deviation PD in the −X direction becomes greater in the −X direction as it is plotted farther away from the reference circle. The graph of FIG. 8 includes a plurality of the deviation axes A_{PD} intersecting in an asterisk pattern. However, the number of the deviation axes A_{PD} may also be one.

A point (α2, pd2) in FIG. 8 represents a correspondence between the angle of rotation RA=α2 and the positional deviation PD=pd2. A point (α3, pd3) in FIG. 8 represents a correspondence between the angle of rotation RA=α3 and the positional deviation PD=pd3. Among the plurality of the positional deviations PD shown in FIG. 8, pd2 is the maximum value in the +X direction. Among the plurality of the positional deviations PD shown in FIG. 8, pd3 is the maximum value in the −X direction.

The display control unit 54 causes the display unit 34 to display thereon a graph (refer to FIG. 8) showing the corresponding relationship between the plurality of the angles of rotation RA, and the plurality of the positional deviations PD associated respectively with the plurality of the angles of rotation RA. In this instance, the graph that is displayed on the display unit 34 represents an observation result of the balance state of the rotating body 16. The corresponding relationship indicated by the graph is the corresponding relationship that is stored in the storage unit 38 by the second storage control unit 50B.

In addition, there is furthermore displayed on the display control unit 54 an auxiliary line L_{RA} on the graph (refer to FIG. 8). The auxiliary line L_{RA} indicates a current rotational position (rotational angle RA) of the rotating body 16. By referring to the auxiliary line L_{RA}, the operator is capable of easily grasping the current rotational position of the rotating body 16. For example, the auxiliary line L_{RA} in FIG. 8 indicates an angle of α4 degrees on the angular axis A_{RA}. Accordingly, on the basis of the auxiliary line L_{RA}, the operator is capable of easily grasping that the current angle of rotation RA of the rotating body 16 is an angle of α4 degrees.

The graph of FIG. 8 is created on the basis of the angles of rotation RA and the positional deviations PD. The angles of rotation RA and the positional deviations PD are numerical information that can be acquired from the machine tool 14. Accordingly, the observation device 12 is capable of observing the balance state of the rotating body 16, without the need for a separate device such as a field balancer.

Observation of the balance state of the rotating body 16 by the observation device 12 can be executed by connecting the observation device 12 and the control device 26 in a manner so as to be capable of communicating with each other. In this case, it is not necessary to use a field balancer. Accordingly, the observation result of the balance state of the rotating body 16 does not depend on how the field balancer is attached, and the attachment position thereof. Consequently, the observation device 12 according to the present embodiment can stably acquire a highly accurate observation result.

The first compensation unit 52 compensates the current angle of rotation RA (the auxiliary line L_{RA}) that is displayed on the display unit 34, on the basis of the first angular difference AD₁. For example, the first angular difference AD₁ that is stored in the storage unit 38 is an angle of 90 degrees. In this case, the first compensation unit 52 compensates the current angle of rotation RA indicated by the auxiliary line L_{RA}, by 90 degrees along a direction that is opposite to the direction of rotation D_{R}.

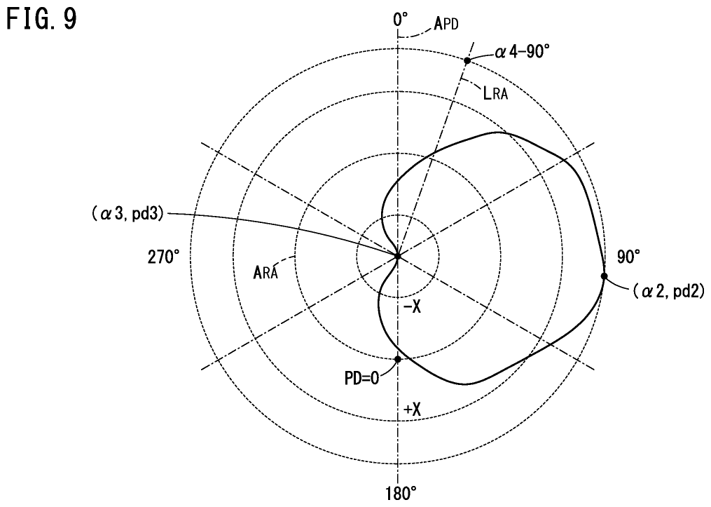

FIG. 9 is a diagram illustrating the graph of FIG. 8 together with an auxiliary line L_{RA} showing the current angle of rotation RA compensated by the first compensation unit 52.

Based on the compensation result of the first compensation unit 52, the above-described display control unit 54 causes the graph and the auxiliary line L_{RA} to be displayed on the display unit 34. For example, the first angular difference AD₁ is an angle of 90 degrees. Further, in that case, the angle of rotation RA detected by the first detector 18 is an angle of α4 degrees. In such a case, when the angle of rotation RA of the auxiliary line L_{RA} is compensated, the auxiliary line L_{RA} shown in FIG. 9 is displayed on the display unit 34. The auxiliary line L_{RA} shown in FIG. 9 indicates an angle of α4 −90 degrees. More specifically, the auxiliary line L_{RA} shown in FIG. 9 is shifted in a direction opposite to the direction of rotation D_{R} by the first angular difference AD₁ (90 degrees) from the angle α4. Although not illustrated herein, if the first angular difference AD₁ is an angle of −90 degrees, the auxiliary line L_{RA} after compensation thereof is an angle of α4 +90 degrees.

A description of an exemplary configuration of the observation device 12 according to the present embodiment has been presented above. Subsequently, an observation method performed by the observation device 12 will be described.

FIG. 10 is a flowchart illustrating a process flow of the observation method according to the embodiment.

The observation method includes a command output step S1, a first acquisition step S2, a second acquisition step S3, a first storage step S4, a second storage step S5, a compensation step (first compensation step) S6, and a display control step S7 (refer to FIG. 10).

In the command output step S1, the command output unit 44 issues a command to the machine tool 14. Such a command includes content to cause the rotating body 16 to be rotated, and content to cause the moving body 20 to be stopped at a predetermined position. The command output step S1 is started, for example, by the operator providing an instruction to the observation device 12 via the operation unit 36.

In the first acquisition step S2, the first acquisition unit 46 acquires the plurality of the angles of rotation RA on the basis of detection signals from the first detector 18. The first acquisition step S2 is executed after initiation of the command output step S1.

In the second acquisition step S3, the second acquisition unit 48 acquires the plurality of the positional deviations PD. The second acquisition step S3 is executed after the command output step S1. In a case that the second acquisition step S3 is executed in parallel with the first acquisition step S2, it is efficient in terms of time.

In the first storage step S4, the first storage control unit 50A causes the first angular difference AD₁ to be stored in the storage unit 38. The first storage step S4 is executed prior to initiation of the first compensation step S6, which will be described later. Moreover, the first storage step S4 may be executed prior to the command output step S1.

In the second storage step S5, the second storage control unit 50B associates the plurality of the angles of rotation RA with the positional deviations PD corresponding respectively to the plurality of the angles of rotations RA, and stores them in the storage unit 38. The second storage step S5 is carried out after the first acquisition step S2 and the second acquisition step S3.

In the first compensation step S6, the first compensation unit 52 compensates the current angle of rotation RA, on the basis of the first angular difference AD₁.

In the display control step S7, the display control unit 54 causes the display unit 34 to display a graph showing the corresponding relationship between the plurality of the angles of rotation RA and the plurality of the positional deviations PD. The display control step S7 is executed after both of the second storage step S5 and the first compensation step S6 have been completed. Moreover, in the display control step S7, the current angle of rotation RA that has been compensated in the first compensation step S6 is displayed together with the graph, on the display unit 34. A description of an exemplary configuration of the observation method according to the present embodiment has been presented above.

As will be described hereinafter, the observation device 12 and the observation method contribute to the operator easily carrying out the balance correcting operation of the rotating body 16.

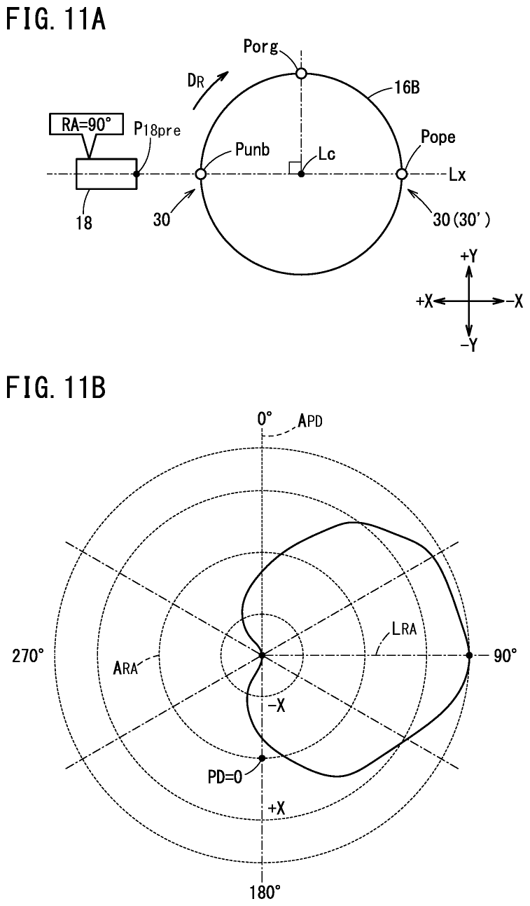

FIG. 11A is a schematic diagram for providing a description concerning a balance correcting operation for a case in which the weight 28 is attached or detached at the predetermined operating position Pₒₚₑ. FIG. 11B is a diagram illustrating a graph and an auxiliary line L_{RA} displayed by the display control unit 54 in the case of FIG. 11A.

Hereinafter, a description will be given concerning the balance correcting operation in the case that the operator attaches and detaches the weight 28 at the predetermined operating position Pₒₚₑ. For the purposes of this illustration, reference will be made to FIG. 11A and FIG. 11B.

In the example shown in FIG. 11A, the predetermined operating position Pₒₚₑ is positioned on the line Lₓ more in the −X direction than the rotating portion 16B. In this example, the first detector 18 is ideally installed at the predetermined installation position P₁₈ₚᵣₑ.

When the balance state is observed in this example, the graph of FIG. 11B is displayed on the display unit 34. In the graph shown in FIG. 11B, the angle of rotation RA=90 degrees, and the maximum value of the positional deviation PD in the +X direction correspond to each other.

At a point in time when the positional deviation PD in the +X direction becomes maximized, in the following description, a position on the line Lₓ more in the +X direction than the central line of rotation L_{c} will be referred to as an “unbalanced position P_{unb}”. The unbalanced position P_{unb} is a position (rotational position) on the rotating portion 16B. Accompanying the rotation of the rotating portion 16B, the unbalanced position P_{unb} moves along the direction of rotation D_{R}. In the example shown in FIG. 11A, as noted previously, the point in time when the positional deviation PD in the +X direction becomes maximum is a point in time when the angle of rotation RA has become 90 degrees.

In this case, at the point in time when the angle of rotation RA is an angle of 90 degrees, the operator installs the weight 28 into the weight attachment and detachment portion 30 that is at the predetermined operating position Pₒₚₑ along the direction of rotation D_{R}. By such installation of the weight, the unbalanced state of the rotating body 16 in FIG. 11A is efficiently adjusted. In other words, in the case that the rotating portion 16B is in an unbalanced state, the position of the center of gravity of the rotating portion 16B is shifted in a direction toward the unbalanced position P_{unb} as viewed from the central line of rotation L_{c}. Accordingly, the operator installs the weight 28 into the weight attachment and detachment portion 30 that is positioned at an angle of 180 degrees along the direction of rotation D_{R} from the unbalanced position P_{unb}. Consequently, the position of the center of gravity of the rotating portion 16B is efficiently brought into close proximity to the position of the central line of rotation L_{c}. In this instance, the weight attachment and detachment portion 30 that is positioned at an angle of 180 degrees along the direction of rotation D_{R} from the unbalanced position P_{unb} is at the predetermined operating position Pₒₚₑ along the direction of rotation D_{R} at the time when the angle of rotation RA is an angle of 90 degrees. In the following, the weight attachment and detachment portion 30 which is at the predetermined operating position Pₒₚₑ is also referred to as a weight attachment and detachment portion 30′.

In the example shown in FIG. 11A, the operator refers to the auxiliary line L_{RA}. On the basis of the angle of rotation RA indicated by the auxiliary line L_{RA}, the operator adjusts the angle of rotation RA of the rotating body 16 (the rotating portion 16B) to an angle of 90 degrees. Thereafter, the operator installs the weight 28 into the weight attachment and detachment portion 30′. Consequently, the operator can suitably correct the balance state of the rotating body 16.

In addition, in the example shown in the example of FIG. 11A, the first detector 18 is installed at the installation position P₁₈ₚᵣₑ. The installation position P₁₈ₚᵣₑ is a position, on the line Lₓ, more in the +X direction than the rotating portion 16B. In this case, the angle of rotation RA corresponding to the maximum value of the positional deviation PD in the +X direction represents the angle of rotation RA at which the unbalanced position P_{unb} arrives at the installation position P₁₈ₚᵣₑ in the direction of rotation D_{R}. Accordingly, by causing the rotational position of the rotating body 16 to be in alignment with the angle of rotation RA that corresponds to the maximum value of the positional deviation PD in the +X direction, the operator is capable of easily achieving alignment of the unbalanced position P_{unb} to a position at an angle of 180 degrees along the direction of rotation D_{R} from the predetermined operating position Pₒₚₑ. Therefore, the operator is capable of easily carrying out the correcting operation of the unbalanced state.

Moreover, it should be noted that at the point in time when the angle of rotation RA has become an angle of 270 degrees, the weight attachment and detachment portion 30′ shown in FIG. 11A and the unbalanced position P_{unb} are mutually at the same position in relation to the direction of rotation D_{R}. In other words, if the rotating body 16 is further rotated by an angle of 180 degrees, the unbalanced position P_{unb} shown in FIG. 11A arrives at the predetermined operating position Pₒₚₑ in the direction of rotation D_{R}. In this case, at the point in time when the angle of rotation RA has become an angle of 270 degrees, the operator may detach the weight 28 from the weight attachment and detachment portion 30′. By such detaching of the weight, the operator is capable of efficiently bringing the position of the center of gravity in close proximity to the central line of rotation L_{c}.

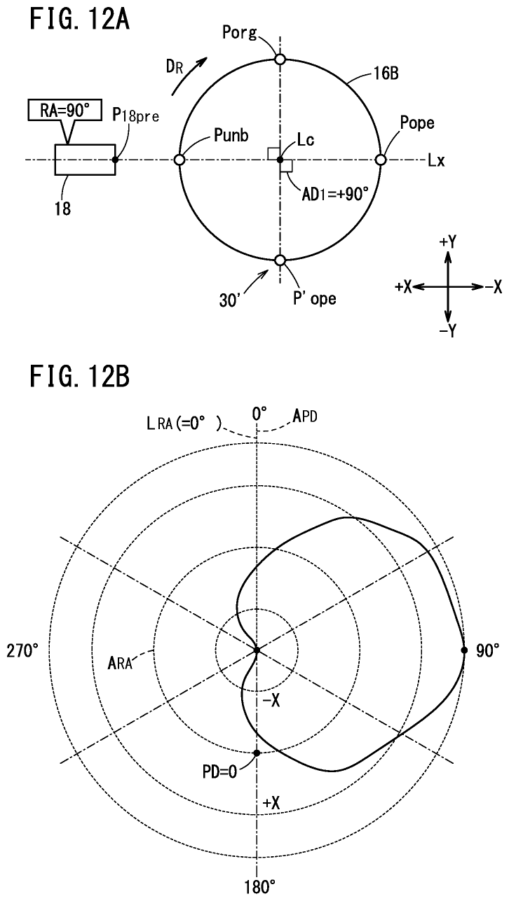

FIG. 12A is a schematic diagram for providing a description concerning the balance correcting operation for a case in which the position for attaching or detaching the weight 28 is changed from the predetermined operating position Pₒₚₑ. FIG. 12B is a diagram illustrating a graph and an auxiliary line L_{RA} displayed by the display control unit 54 in the case of FIG. 12A.

Next, a description will be given of the balance correcting operation in the case that the position for attaching or detaching the weight 28 is changed from the predetermined operating position Pₒₚₑ. For the purposes of this illustration, reference will be made to FIG. 12A and FIG. 12B. The mutual positional relationship of the position of the first detector 18, the origin point P_{org}, and the unbalanced position P_{unb} with respect to each other in FIG. 12A is the same as in the illustration shown in FIG. 11A. However, in the example shown in FIG. 12A, the first angular difference AD₁ is occurring. More specifically, the actual operating position P′ₒₚₑ differs from the predetermined operating position Pₒₚₑ. In this example, the first angular difference AD₁ is an angle of +90 degrees.

In the illustration shown in FIG. 12A, in the case that the current angle of rotation RA indicated by the auxiliary line L_{RA} is not compensated on the basis of the first angular difference AD₁, the operator is incapable of correcting the unbalanced state of the rotating body 16 in the same manner as in the example shown in FIG. 11A. More specifically, in the example shown in FIG. 12A, at the point in time when the angle of rotation RA is an angle of 90 degrees, the unbalanced position P_{unb} is not positioned at an angle of 180 degrees along the direction of rotation D_{R} from the operating position P′ₒₚₑ. In this case, even if the weight 28 is installed in the weight attachment and detachment portion 30′ that has arrived at the operating position P′ₒₚₑ, the center of gravity of the rotating portion 16B does not efficiently come into close proximity to the central line of rotation L_{c}. In this example, in order to align the unbalanced position P_{unb} with the position that is positioned at an angle of 180 degrees along the direction of rotation D_{R} from the operating position P′ₒₚₑ, it is necessary to further cause the rotating portion 16B to be rotated by the first angular difference AD₁ (by an angle of 90 degrees).

In this instance, the current angle of rotation RA indicated by the auxiliary line L_{RA} is an angle of rotation RA that is compensated by the first angular difference AD₁ (refer to FIG. 12B). Consequently, the operator, by causing the angle of rotation RA indicated by the auxiliary line L_{RA} to be placed in alignment with the angle of rotation RA corresponding to the maximum value of the positional deviation PD, is capable of bringing the unbalanced position P_{unb} into alignment with the position that is positioned at an angle of 180 degrees from the operating position P′ₒₚₑ along the direction of rotation D_{R}.

In other words, in the example of FIG. 12A and FIG. 12B, in the case that the angle of rotation RA indicated by the auxiliary line L_{RA} is aligned with an angle of 90 degrees, the actual angle of rotation RA of the rotating body 16 reaches an angle of 180 degrees. In this example, at the point in time when the angle of rotation RA is 180 degrees, the unbalanced position P_{unb} arrives at the position that is positioned at an angle of 180 degrees along the direction of rotation D_{R} from the operating position P′ₒₚₑ.

Accordingly, in the case that the auxiliary line L_{RA} indicates an angle of 90 degrees (actually, 180 degrees), by installing the weight 28 in the weight attachment and detachment portion 30, the operator is capable of correcting the unbalanced state of the rotating body 16.

As noted previously, according to the present embodiment, the observation device 12 and the observation method are provided. The observation device 12 executes the observation method. Consequently, the observation device 12 observes the balance state of the rotating body 16 of the machine tool 14, without the presence of a field balancer. As a result, the observation device 12 facilitates the balance correcting operation of the rotating body 16 to be carried out by the operator.

### EXEMPLARY MODIFICATIONS

Hereinafter, a description will be given concerning exemplary modifications of the embodiment. However, explanations that overlap with those of the embodiment will be omitted insofar as possible in the following description. Unless otherwise specified, the same reference numerals as in the embodiment are used in referring to the constituent elements that have already been described in the embodiment.

### Exemplary Modification 1

The embodiment has been described on the assumption that the first detector 18 is installed at the predetermined installation position P₁₈ₚᵣₑ However, the position where the first detector 18 is installed may be a position that differs from the installation position P₁₈ₚᵣₑ Based on the aforementioned feature, a description of the present exemplary modification will be presented below. Moreover, in the following description, the position where the first detector 18 is actually installed is also referred to as an installation position P₁₈ in order to distinguish it from the installation position P₁₈ₚᵣₑ.

The storage unit 38 according to the present exemplary modification further stores a second angular difference AD₂. The second angular difference AD₂ is a phase difference in angle in the direction of rotation D_{R} between the installation position P₁₈ₚᵣₑ and the installation position P n.

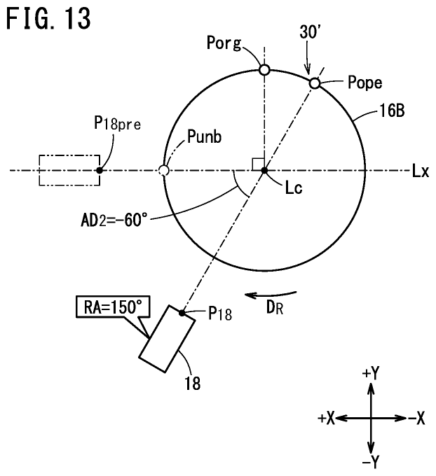

FIG. 13 is a schematic diagram illustrating the second angular difference AD₂ that is stored in the storage unit 38.

Hereinafter, a specific example of the second angular difference AD₂ will be described. FIG. 13 illustrates the positional relationship between the rotating portion 16B and the first detector 18. The first detector 18 is installed at the installation position P₁₈. In this instance, the installation position P₁₈ is a position that is −60 degrees from the predetermined installation position P₁₈ₚᵣₑ of the first detector 18 along the direction of rotation D_{R}. In this case, the second angular difference AD₂ is an angle of −60 degrees. Moreover, it should be noted that the second angular difference AD₂ is not limited to being an angle of −60 degrees.

The second angular difference AD₂ is stored in the storage unit 38 by the first storage control unit 50A. For example, in the case that the operator has input the second angular difference AD₂ via the operation unit 36, the first storage control unit 50A causes the second angular difference AD₂ that has been input to be stored in the storage unit 38.

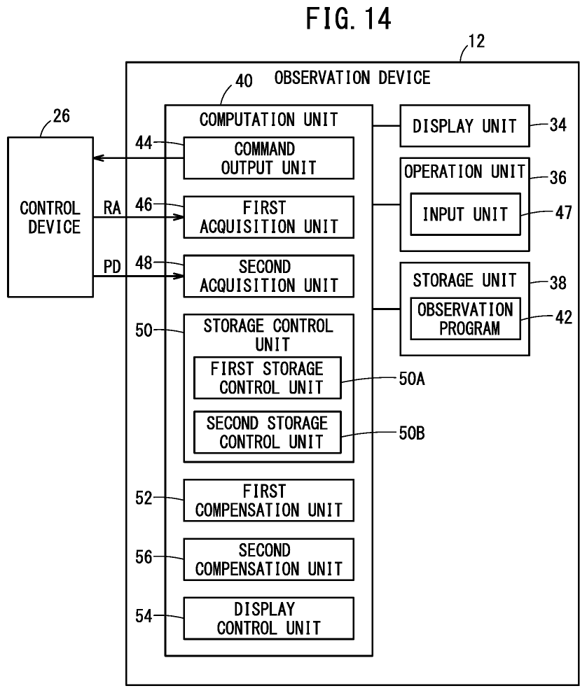

FIG. 14 is a configuration diagram of the observation device 12 according to an Exemplary Modification 1.

The observation device 12 according to the present exemplary modification is further equipped with a second compensation unit 56. On the basis of the second angular difference AD₂, the second compensation unit 56 compensates the angle of rotation RA corresponding to each of the plurality of the positional deviations PD on the graph. For example, the second angular difference AD₂ is an angle of −60 degrees. In this case, the second compensation unit 56 compensates the angle of rotation RA corresponding to each of the plurality of the positional deviations PD, with the angle of −60 degrees. In accordance with this feature, a graph is displayed on the display unit 34 showing a corresponding relationship between the plurality of the angles of rotation RA as compensated on the basis of the second angular difference AD₂, and the positional deviation PD associated with each of the angles of rotation RA.

Hereinafter, with further reference to FIG. 13, the balance correcting operation according to the present exemplary modification will be described. Moreover, in the example shown in FIG. 13, the positional relationship between the origin point P_{org} and the unbalanced position P_{unb} is the same as in the example shown in FIG. 11A. Further, in this example, the operating position is not changed. Accordingly, the first angular difference AD₁ is zero.

In the case that the angle of rotation RA has reached an angle of 150 degrees, the unbalanced position P_{unb} shown in FIG. 13 arrives at a position on the line Lₓ in the +X direction from the central line of rotation L_{c}. Accordingly, in the case of the situation shown in FIG. 13, the angle of rotation RA corresponding to the maximum value of the positional deviation PD in the +X direction is 150 degrees.

In this instance, at the point in time when the angle of rotation RA is an angle of 150 degrees, the unbalanced position P_{unb} is not at the position that is at an angle of 180 degrees along the direction of rotation D_{R} from the predetermined operating position Pₒₚₑ (refer to FIG. 13). Accordingly, at the point in time when the angle of rotation RA is 150 degrees, even if the operator installs the weight 28 in the weight attachment and detachment portion 30′ that is at the predetermined operating position Pₒₚₑ, the center of gravity of the rotating portion 16B does not efficiently come into close proximity to the central line of rotation L_{c}.

In regard to this point, the second compensation unit 56 according to the present modification compensates each of the plurality of the angles of rotation RA based on the second angular difference AD₂. For example, based on the second angle difference AD 2=−60 degrees, the angle of rotation RA=150 degrees is compensated to an angle of rotation RA=90 degrees. In the example shown in FIG. 13, at the point in time when the angle of rotation RA is an angle of 90 degrees (=150 degrees −60 degrees), the unbalanced position P_{unb} arrives at the installation position P₁₈.

Based on the above, in the example shown in FIG. 13, the operator adjusts the angle of rotation RA to an angle of 90 degrees. Consequently, the unbalanced position P_{unb} arrives at the installation position P₁₈. As a result, even in the case that the installation position P₁₈ of the first detector 18 differs from the installation position P₁₈ₚᵣₑ, the operator is capable of carrying out the balance correcting operation in a satisfactory manner.

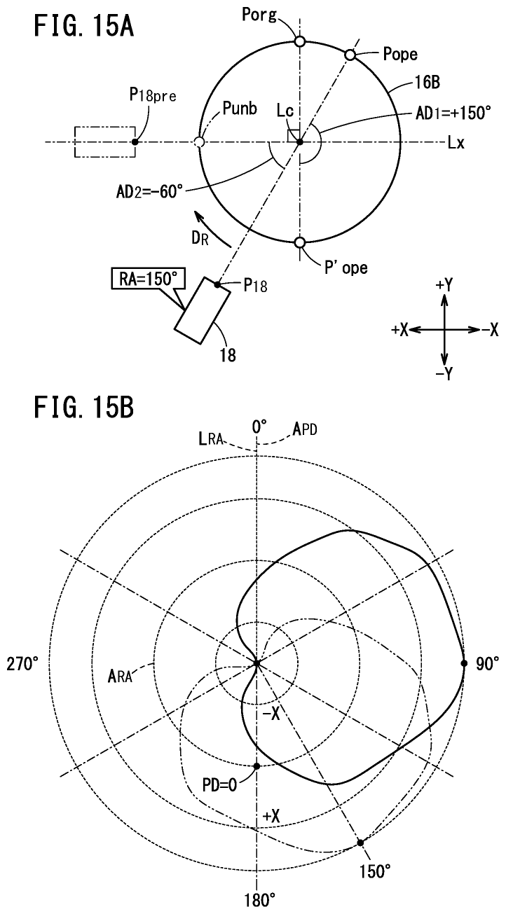

FIG. 15A is a schematic diagram for providing a description concerning the balance correcting operation for a case in which the first detector 18 is not installed in the predetermined installation position P₁₈ₚᵣₑ, and further, the position for attaching or detaching the weight 28 is changed from the predetermined operating position Pₒₚₑ. FIG. 15B is a diagram illustrating a graph and an auxiliary line L_{RA} displayed by the display control unit 54 in the case of FIG. 15A.

Next, with reference to FIG. 15A and FIG. 15B, another example of the balance correcting operation according to the present exemplary modification will be described. In FIG. 15A, the positional relationship between the origin point P_{org} and the unbalanced position P_{unb}, and the positional relationship between the installation position P₁₈ₚᵣₑ and the installation position P n are the same as shown in FIG. 13. However, in the example shown in FIG. 15A, the position at which the weight 28 is attached or detached is changed from the predetermined operating position Pₒₚₑ to the operating position P′ₒₚₑ. Accordingly, the first angular difference AD₁ is generated. In this example, the first angular difference AD₁ is an angle of 150 degrees.

In this case, the first compensation unit 52 compensates the angle of rotation RA indicated by the auxiliary line L_{RA} on the basis of the first angular difference AD₁. Further, on the basis of the second angular difference AD₂, the second compensation unit 56 compensates the angle of rotation corresponding to each of the plurality of the positional deviations PD on the graph. The compensation of the angle of rotation RA by the second compensation unit 56 (the second compensation step), for example, is performed in parallel with the display of the graph by the display control unit 54 in the display control step S7.

The angle of rotation RA associated with each of the plurality of the positional deviations PD is compensated along the direction of rotation D_{R} by the second angular difference AD₂=−60 degrees. Consequently, for example, the angle of rotation RA corresponding to the maximum value of the positional deviation PD is compensated from an angle of 150 degrees to an angle of 90 degrees (150 degrees 60 degrees). As a result thereof, in the graph in FIG. 15B, a phase (the solid line) is displayed that is shifted by an angle of −60 degrees along the direction of rotation D_{R} from the phase prior to being compensated (the two-dot dashed line).

On the other hand, the angle of rotation RA indicated by the auxiliary line L_{RA} is compensated by the first angular difference AD₁=150 degrees in an opposite direction to the direction of rotation D_{R} (see FIG. 15B). Thus, for example, the auxiliary line L_{RA} indicates an angle of 0 degrees (150 degrees −150 degrees) at the point in time when the actual angle of rotation RA of the rotating body 16 is an angle of 150 degrees. Accordingly, at the point in time when the actual angle of rotation RA of the rotating body 16 is an angle of 240 degrees, the auxiliary line L_{RA} indicates an angle of 90 degrees (240 degrees 150 degrees). The point in time when the actual angle of rotation RA of the rotating body 16 is an angle of 240 degrees is a point in time when the unbalanced position P_{unb} shown in FIG. 15A arrives at the position that is at an angle of 180 degrees along the direction of rotation D_{R} from the operating position P′ₒₚₑ.

In the example shown in FIG. 15A and FIG. 15B, at a point in time when the auxiliary line L_{RA} indicates that the angle of rotation RA=90 degrees, the operator installs the weight 28 in the weight attachment and detachment portion 30′ that has arrived at the operating position P′ₒₚₑ. As a result, even if the installation position P13 of the first detector 18 differs from the installation position P₁₈ₚᵣₑ, and further, the operating position P′ₒₚₑ differs from the predetermined operating position Pₒₚₑ, the operator can satisfactorily carry out the balance correcting operation.

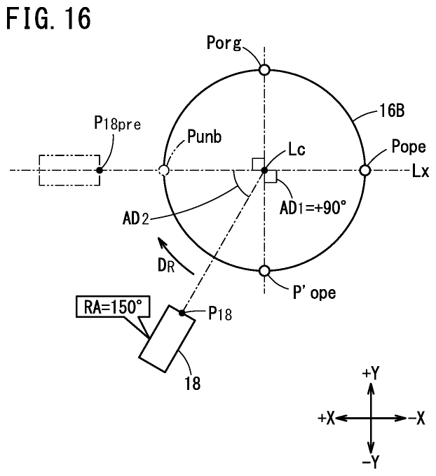

FIG. 16 is a schematic diagram for providing a supplementary description concerning application of the Exemplary Modification 1.

A case is also assumed in which the predetermined operating position Pₒₚₑ is at a position that is at an angle of 180 degrees from the installation position P₁₈ₚᵣₑ along the direction of rotation D_{R}. In this case, regardless of the present exemplary modification, the second compensation unit 56 does not compensate the angle of rotation RA. For example, in the case shown in FIG. 16, an angle of −60 degrees is generated as the second angular difference AD₂, but such a second angular difference AD₂ is ignored. In this case, the operator adjusts the angle of rotation RA indicated by the auxiliary line L_{RA} that has been compensated based on the first angular difference AD₁, to an angle of 150 degrees (the actual angle of rotation RA is an angle of 240 degrees). As a result, in the example shown in FIG. 16, the unbalanced position P_{unb} arrives at a position that is an angle of 180 degrees along the direction of rotation D_{R} from the operating position P′ₒₚₑ.

### Exemplary Modification 2

In the following, the term “polarity” will be described. Further, based on such a description, the observation device 12 of the present exemplary modification will be described. Moreover, in the same manner as in the embodiment (refer to FIG. 1), the movement axis according to the present embodiment is parallel to the X-axis.

The polarity is information that determines which direction of the two directions along the X-axis is the +X direction (the first direction) (or the −X direction (the second direction)). The positive and negative signs of the positional deviation PD are determined in accordance with this polarity. For example, when a positional deviation PD occurs in one direction along the X-axis, if the one direction is defined as the +X direction in the polarity, the positional deviation PD is expressed with a negative polarity, based on the polarity. More specifically, such a negative positional deviation PD represents a shifting in an opposite direction to the +X direction. Further, when a positional deviation PD occurs in one direction along the X-axis, if the one direction is defined as the −X direction in the polarity, the positional deviation PD is expressed with a positive polarity, based on the polarity. More specifically, such a positive positional deviation PD represents a shifting in an opposite direction to the −X direction.

The control device 26 calculates the positional deviation PD on the basis of the polarity. Accordingly, the control device 26 possesses information in relation to the polarity. In this case, the observation device 12 is capable of acquiring the information on the polarity from the control device 26. In this instance, for example, concerning two of the machine tools 14, there is a case that they may have polarity settings that are opposite from each other. In this case, even if the absolute direction and the absolute value of the positional deviation PD are exactly the same, the positive and the negative signs of the observation results (the graphs) of the two machine tools 14 are mutually reversed.

Based on the foregoing description, the observation device 12 of the present exemplary modification will be described.

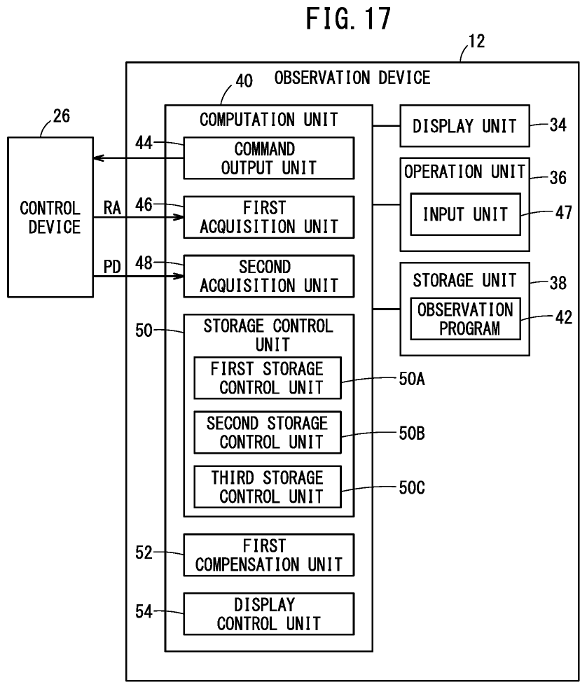

FIG. 17 is a configuration diagram of the observation device 12 according to an Exemplary Modification 2.

The storage control unit 50 according to the present exemplary modification further includes a third storage control unit 50C (refer to FIG. 17). The third storage control unit 50C causes the storage unit 38 to store therein the polarities in the +X direction and the −X direction along the X-axis. In accordance with this feature, according to the present exemplary modification, the polarities concerning the observation device 12 are stored in the storage unit 38.

In relation to the above description, the observation method may further include a polarity determination step in which the observation device 12 (the computation unit 40) designates the polarity. The third storage control unit 50C causes the storage unit 38 to store the polarity specified in the polarity determination step. Further, instead of the polarity determination step, the observation method may include an operation step in which the operator designates the polarity via the operation unit 36. The third storage control unit 50C may cause the storage unit 38 to store the polarity specified in the operation step.

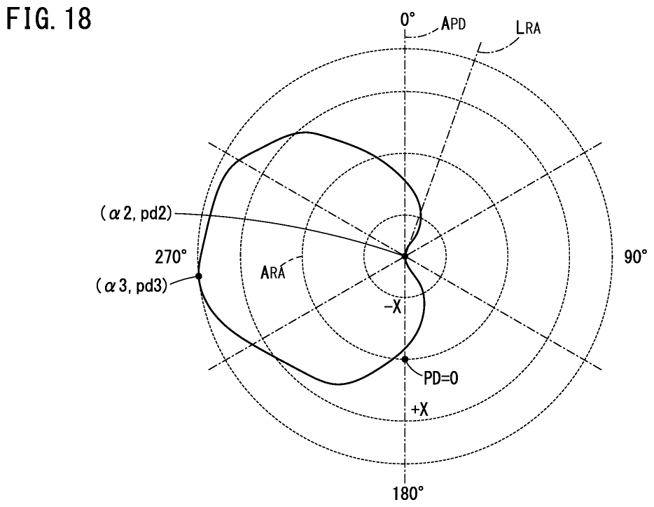

FIG. 18 is a graph obtained by reversing the polarity in the graph of FIG. 9.

In the case that the display unit 34 is made to display the graph, the display control unit 54 compares the polarity set in the machine tool 14 and the polarity that is stored in the storage unit 38. If the polarity set in the machine tool 14 and the polarity stored in the storage unit 38 are opposite to each other, the display control unit 54 causes the polarity concerning the plurality of the positional deviations PD displayed on the display unit 34 to be inverted in accordance with the polarity that is stored in the storage unit 38 (refer to FIG. 18).

In accordance with such features, insofar as the same observation device 12 is used, even if the observation is carried out on a plurality of the machine tools 14 the polarities of which are different, the operator can refer to the observation results with a unified polarity. In this case, the “+” sign and the “−” sign in FIG. 18 represent the polarity that is set in the observation device 12.

### Exemplary Modification 3

In relation to the Exemplary Modification 1, the second acquisition unit 48 and the second storage control unit 50B may refer to the polarity that is stored in the storage unit 38 by the third storage control unit 50C. For example, the second acquisition unit 48 may change the positive and the negative of the positional deviation PD in accordance with the polarity that is set in the observation device 12 at the point in time when the positional deviation PD is acquired. Further, for example, the second storage control unit 50B may change the positive and the negative of the positional deviation PD in accordance with the polarity that is set in the observation device 12 at the point in time when the angle of rotation RA is associated with the positional deviation PD.

### Modification 4

The positive and negative of the positional deviation PD according to Exemplary Modifications 1 and 2 is reversed in accordance with the polarity. However, instead of the positive and negative of the positional deviation PD, the axes of the graph showing the observation result may be reversed in accordance with the polarity. Based on this, a description of the present exemplary modification will be presented below. Moreover, in the following, the polarity of the observation device 12 is previously stored in the storage unit 38.

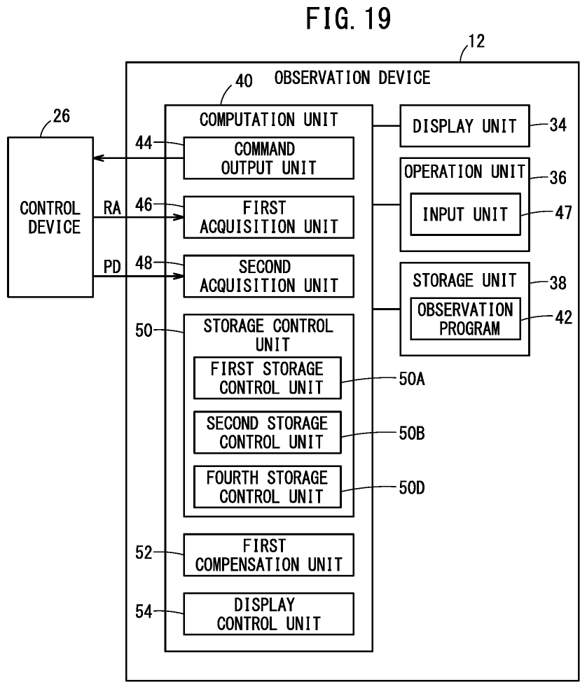

FIG. 19 is a configuration diagram of the observation device 12 according to an Exemplary Modification 4.

The storage control unit 50 according to the present exemplary modification further includes a fourth storage control unit 50D (refer to FIG. 19). The fourth storage control unit 50D causes the orientation of the deviation axis A_{PD} to be stored in the storage unit 38 (refer to FIG. 9). More specifically, the fourth storage control unit 50D causes the orientation concerning the magnitude of the positional deviation PD indicated by the deviation axis A_{PD} to be stored in the storage unit 38. Moreover, it should be noted, in a graph having a form that differs from that shown in FIG. 9, the magnitude of the positional deviation PD may be represented by an axial line other than the deviation axis App. In this case, the fourth storage control unit 50D may cause the storage unit 38 to store the orientation (i.e., which direction is plus (or minus)) concerning the magnitude in the axial line indicating the magnitude of the positional deviation PD.

In the Exemplary Modification 2, the polarity that is set in the machine tool 14 and the polarity that is stored in the storage unit 38 are compared by the display control unit 54. In a similar manner, the fourth storage control unit 50D compares the polarity that is set in the machine tool 14, and the polarity that is stored in the storage unit 38. If the polarity that is set in the machine tool 14 and the polarity that is stored in the storage unit 38 are opposite to each other, the fourth storage control unit 50D determines the orientation of the deviation axis A_{PD} in accordance with the polarity that is stored in the storage unit 38. Further, the fourth storage control unit 50D causes the determined orientation of the deviation axis A_{PD} to be stored in the storage unit 38. Moreover, the observation method according to the embodiment may further include an operation step of allowing the operator to specify an orientation concerning the magnitude via the operation unit 36. In this case, the fourth storage control unit 50D may cause the storage unit 38 to store the orientation concerning the magnitude that is specified in the operation step.

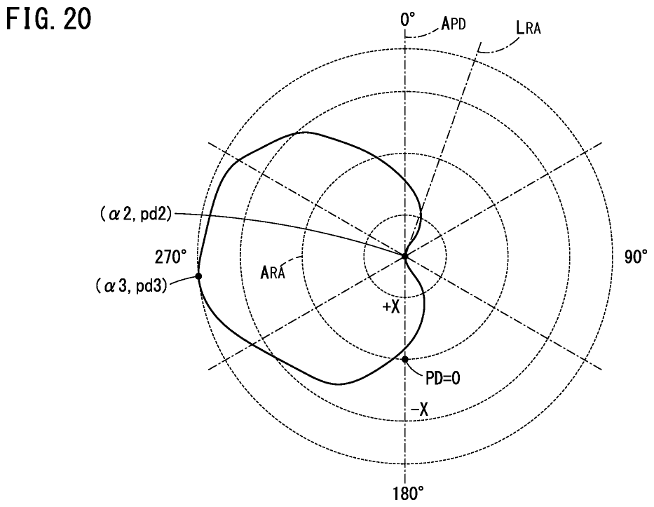

FIG. 20 is a graph obtained by reversing the orientation concerning the magnitude (plus/minus) in the deviation axis A_{PD} of the graph of FIG. 9.

In the case that the display unit 34 is made to display the graph, the display control unit 54 refers to the direction of the deviation axis line A_{PD} that is stored in the storage unit 38. The display control unit 54 determines the region of the positive polarity and the region of the negative polarity in accordance with the direction of the deviation axis line A_{PD} that has been referred to (refer to FIG. 20).

According to the present exemplary modification, the display control unit 54 changes the direction of the deviation axis line A_{PD} in accordance with the polarity that is set in the machine tool 14. For example, in the deviation axis line A RID shown in FIG. 9, the direction toward the center of the angular axis line A_{RA} is a direction of a negative polarity. In this instance, in the case that the polarity that is set in the machine tool 14 and the polarity that is stored in the storage unit 38 are opposite to each other, the direction of the negative polarity is changed to a direction oriented radially outward of the angular axis line A_{RA}. In this case, the plus sign (+) and the minus sign (−) shown in FIG. 20 represent the polarity that is set in the machine tool 14.

### Exemplary Modification 5

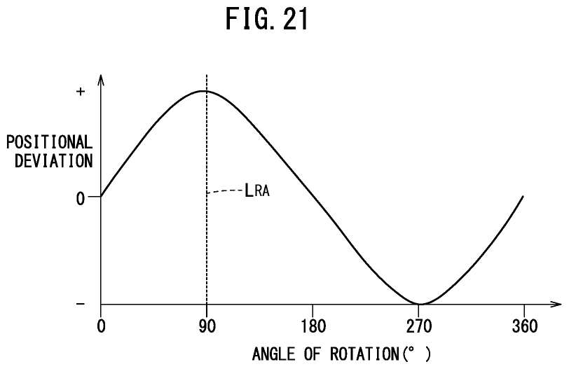

FIG. 21 is a graph illustrating a corresponding relationship between the plurality of the angles of rotation RA and the positional deviations PD corresponding respectively to the plurality of the angles of rotation RA.

The formulation of the graph showing the observation results is not limited to the format shown in FIG. 8 or FIG. 9. For example, the corresponding relationship between the plurality of the angles of rotation RA and the plurality of the positional deviations PD may be represented using the formulation shown in FIG. 21. The graph of FIG. 21 includes a vertical axis representing the positional deviation PD, and a horizontal axis representing the angle of rotation RA.

The display control unit 54 may cause both the graph of FIG. 9 and the graph of FIG. 21 to be displayed on the display unit 34. Further, the display control unit 54 may allow the operator to select the formulation of the graph to be displayed on the display unit 34. In that case, the operation unit 36 may receive a selection operation made by the operator.

### Exemplary Modification 6

The method by which the current angle of rotation RA of the rotating body 16 is indicated to the operator is not limited to causing the auxiliary line L_{RA} to be displayed (see FIG. 9). For example, the display control unit 54 may cause numerical values indicating the angle of rotation RA to be displayed on the screen of the display unit 34. Further, for example, the display control unit 54 may cause an icon that moves along a circle represented by the angular axis A_{RA} to be displayed on the screen of the display unit 34.

### Exemplary Modification 7

In the embodiment, the predetermined installation position P₁₈ₚᵣₑ of the first detector 18 is on the line Lₓ, and positioned more in the +X direction than the rotating portion 16B. However, the installation position P₁₈ₚᵣₑ is not limited to this position. For example, the installation position P₁₈ₚᵣₑ may be on the line Lₓ, and may be positioned more in the −X direction than the rotating portion 16B.

### Exemplary Modification 8

The movement axis of the moving body 20 is not limited to being the X-axis, insofar as it is a directional axis perpendicular to the central line of rotation L_{c}. For example, the movement axis may be the Y-axis. In that case, the ball screw (refer to the embodiment) is installed parallel to the Y-axis. In this case, the installation position P₁₈ₚᵣₑ of the first detector 18, for example, is a position on a line passing through the central line of rotation L_{c} and parallel to the Y-axis, and further, which is more in the +Y direction or the −Y direction than the rotating portion 16B. In the case that the movement axis is the Y-axis, the positional deviation PD indicates a shift in the position of the moving body 20 in the Y-axis direction. In this case, the positional deviation PD becomes maximum in the case that the unbalanced position P_{unb} is on a line passing through the central line of rotation L_{c} and parallel to the Y-axis line, and reaches one of the opposite positions in the Y direction of the rotating portion 16B. By installing the weight 28 into a position that is at an angle of 180 degrees along the direction of rotation D_{R} from the unbalanced position P_{unb}, the operator is capable of correcting the unbalanced state of the rotating body 16.

In the case that the movement axis of the moving body 20 is the Y-axis, the second acquisition unit 48 acquires the positional deviation PD in the Y-axis direction. In this case, the second storage control unit 50B associates the compensated plurality of the angles of rotation RA with the plurality of the positional deviations PD in the Y-axis direction.

### Exemplary Modification 9

In relation to the Exemplary Modification 8, the machine tool 14 may be equipped with a moving body 20 that moves in the direction of the X-axis, and another moving body 20 that moves in the direction of the Y-axis. By the plurality of the moving bodies 20 that move in different directions being connected to the main shaft portion 16A, it becomes possible for the rotating body 16 to move in a plurality of directions. In that case, the machine tool 14 is provided with a plurality of the feeding motors 24 that enable the plurality of the moving bodies 20 to move.

In the case that the machine tool 14 is equipped with the plurality of the moving bodies 20 that move along directions of the movement axes that differ from each other, the second acquisition unit 48 acquires the positional deviation PD of either one of the plurality of the directions of the movement axes. In this instance, the operator or the second acquisition unit 48 may select the direction of the movement axis for which the positional deviation PD is acquired. In this case, the second storage control unit 50B associates the compensated plurality of the angles of rotation RA with the plurality of the positional deviations PD in the direction of the movement axis that has been selected.

### Exemplary Modification 10

The display control unit 54 may output a graph showing the observation result, to an external device of the observation device 12. In other words, the display unit 34 that displays the graph may be installed externally of the observation device 12. For example, the display unit 34 may be a display device provided by the machine tool 14.

### Exemplary Modification 11

The observation device 12 may be integrally configured together with the control device 26 of the machine tool 14. In accordance with this feature, the observation device 12 is provided that also functions as the control device 26 of the machine tool 14.

### Exemplary Modification 12

The moving body 20 may be a member that moves relatively to the rotating body 16. In this case, the machine tool 14, for example, is a machining center. A tool is attached to the main shaft portion 16A of the machining center via a tool holder. The machining center, using a tool attached to the main shaft portion 16A, implements a cutting machining process on the workpiece. The workpiece is supported on a table that moves relatively to a main shaft (spindle) 18A. In this case, the rotating portion 16B is the tool holder, or alternatively, the tool itself. Further, the moving body 20 in this case is the table.

### Exemplary Modification 13

A case may exist in which the shaft 22a of the main shaft motor 22 is at the same position as the central line of rotation L c of the rotating portion 16B on a plane parallel to the XY plane. In this case, the first detector 18 may output a signal in accordance with the rotation of the shaft 22a. In this case, the observation device 12 may acquire the angle of rotation of the shaft 22a as the angle of rotation RA of the rotating portion 16B. Further, in this case, for example, a rotary encoder provided on the main shaft motor 22 can be used as the first detector 18.

### Exemplary Modification 14

The weight attachment and detachment portions 30 may be provided on the main shaft portion 16A. In this case, the balance correcting operation of the rotating body 16 is performed by carrying out attachment and detachment of the weight 28 with respect to the weight attachment and detachment portions 30 of the main shaft portion 16A.

### Exemplary Modification 15

The weight 28 may be an adhesive member that is adhered to the rotating body 16. The adhesive member, for example, is an adhesive tape. The balance state of the rotating body 16 is changed even by adhering the adhesive tape. By using the adhesive tape, the operator can easily perform fine adjustment on the balance state of the rotating body 16. Further, from the operator's point of view, the operation of adhering the adhesive tape to the rotating body 16 is easier than the operation of inserting the screws.

The adhesive member is adhered to the rotating body 16. Accordingly, it is not necessary for the weight attachment and detachment portions 30 to be holes. That is, for example, in the case that the balance state of the rotating body 16 is adjusted using the adhesive member, the screw holes described in the embodiment are unnecessary. In this case, each of the plurality of the weight attachment and detachment portions 30 is a portion of the rotating body 16 to which the adhesive member is capable of being adhered.

### Exemplary Modification 16

According to the present embodiment, the moving body 20 is made to move along the movement axis using the ball screw and the feeding motor 24. Alternatively, the moving body 20 may also be moved in response to a linear force along the movement axis generated, for example, by a linear motor or a fluid bearing.

In the case that the moving body 20 is made to move using a linear motor or a fluid bearing, in order to calculate the positional deviation PD, it is necessary to measure the amount of movement of the moving body 20 in the direction of the movement axis. The amount of movement of the moving body 20 in the direction of the movement axis can be measured, for example, by using a scale.

The machine tool 14 which is equipped with the linear motor or the fluid bearing as an element for causing the moving body 20 to move, for example, is an ultra-high-precision machine tool. Such an ultra-high-precision machine tool is a machine tool 14 that carries out machining according to commands. A machining accuracy with which such an ultra-high-precision machine tool performs machining according to the commands is less than or equal to 10 nanometers.

### Exemplary Modification 17

The first compensation unit 52 may compensate the angle of rotation RA, which is associated with the positional deviation PD on the graph, on the basis of the first angular difference AD₁. In this case, the display control unit 54 causes the display unit 34 to display a graph in which the phase of the angle has been shifted by the amount of the first angular difference AD₁ due to the compensation of the first compensation unit 52, and the current angle of rotation RA as it is with the detected value not being compensated by the first angular difference AD₁. Moreover, in this case, the first compensation unit 52 need not necessarily compensate the current angle of rotation RA (the auxiliary line L_{RA}).

### Exemplary Modification 18

The above-described embodiments and the respective modifications thereof may be appropriately combined within a range in which no technical inconsistencies occur.

### Inventions that can be Obtained from the Embodiment

The inventions that can be grasped from the above-described embodiment and the modifications thereof will be described below.

### First Invention

The observation device (12) for observing the balance state of the rotating body of the machine tool (14), the machine tool including the rotating body (16), the detector (18) that detects the angle of rotation (RA) of the rotating body, and the moving body (20) that moves along the movement axis (X) perpendicular to the central line of rotation (L_{c}) of the rotating body, the observation device including the command output unit (44) that issues the command to the machine tool so as to stop the moving body at the predetermined position while the rotating body is made to rotate, the first acquisition unit (46) that acquires the angle of rotation, based on the detection signal of the detector, the second acquisition unit (48) that acquires the positional deviation (PD) of the moving body in the direction of the movement axis, the first storage control unit (50A) which, at a time when the operating position at which the weight (28) for balance adjustment is actually attached to or detached from the rotating body is changed from the predetermined position (Pₒₚₑ) that is determined beforehand as the operating position at which the operator or the robot attaches or detaches the weight to or from the rotating body, stores in the storage unit (38) the first angular difference (AD₁) in the direction of rotation (D_{R}) of the rotating body between the predetermined operating position and the changed operating position (P′ₒₚₑ), the second storage control unit (50B) which stores in the storage unit the plurality of the angles of rotation and the positional deviations corresponding respectively to the plurality of the angles of rotation, in association with each other, the first compensation unit (52) that compensates the angle of rotation associated with the positional deviation or the current angle of rotation (RA) of the rotating body on the basis of the first angular difference, and the display control unit (54) that causes the display unit (34) to display, based on the compensation result of the first compensation unit, the graph showing the corresponding relationship between the plurality of the angles of rotation and the positional deviations that are stored in association with the plurality of the angles of rotation, together with causing the current angle of rotation of the rotating body to be displayed on the graph.

In accordance with such features, the observation device is provided which is capable of observing the balance state of the rotating body of the machine tool, without using the field balancer, and further, which facilitates the balance correcting operation of the rotating body.

The first storage control unit may further cause the storage unit to store the second angular difference (AD₂) in the direction of rotation of the rotating body between the installation position (P₁₈ₚᵣₑ) that is determined beforehand as the position where the detector is to be installed, and the position where the detector is actually installed (P₁₈), the observation device may be further equipped with the second compensation unit (56) that compensates the plurality of the angles of rotation on the basis of the second angular difference, the second storage control unit may cause the storage unit to store the plurality of the angles of rotation compensated by the second compensation unit, and the positional deviations corresponding respectively to the plurality of the angles of rotation compensated by the second compensation unit, in association with each other, and the graph displayed by the display control unit may show the corresponding relationship between the plurality of the angles of rotation compensated by the second compensation unit, and the positional deviations stored in association with the plurality of the angles of rotation compensated by the second compensation unit. With this configuration, even if the detector is not installed at the predetermined installation position, the operator can easily perform the balance correcting operation of the rotating body.

The installation position and the predetermined operating position may be positions on a line (Lₓ) passing through the central line of rotation of the rotating body and parallel to the movement axis, and which sandwich the central line of rotation therebetween. In accordance with this feature, at the time when the positional deviation has become maximum in the first direction or the second direction, the installation position coincides with the unbalanced position of the rotating body in the direction of rotation.

The observation device may be further equipped with the input unit (47) configured to allow the operator to input the first angular difference, wherein the first storage control unit may cause the storage unit to store the first angular difference that has been input. In accordance with this feature, the operator is capable of specifying, as desired, the operating position after having been changed.

The moving body may be capable of moving along the movement axis in the first direction (+X) and in the second direction (−X) opposite to the first direction, the observation device may be further equipped with the third storage control unit (50C) that causes the storage unit to store the polarity concerning the first direction and the second direction, and the display control unit may display the positional deviations with a polarity in accordance with the polarity stored in the storage unit. In accordance with such features, insofar as the same observation device is used, even if the observation is carried out on a plurality of the machine tools the polarities of which are different, the operator can refer to the observation results with a unified polarity.

The observation device may be further equipped with the operation unit (36) that receives the operation of specifying the polarity, wherein the third storage control unit may cause the specified polarity to be stored in the storage unit. In accordance with this feature, the operator is capable of determining the polarity of the observation device, as desired.

The moving body may be capable of moving along the movement axis in the first direction (+X), and in the second direction (−X) opposite to the first direction, in the graph, the positional deviation that occurs in the first direction may be displayed with a positive polarity, and the positional deviation that occurs in the second direction may be displayed with a negative polarity, and the observation device may be further equipped with the fourth storage control unit (50D) that stores in the storage unit the orientation concerning the magnitude, of the axis (A_{PD}) indicating the magnitude of the positional deviation on the graph, and the display control unit may determine the region of the positive polarity and the region of the negative polarity on the graph, in accordance with the orientation concerning the magnitude stored in the storage unit. In accordance with such features, irrespective of the manner in which the polarity of the machine tool is set, the polarity of the direction indicating the positive polarity in the observation device is placed on a determined one side on the axis of the graph. At the same time, the polarity of the direction indicating the direction of the negative polarity in the observation device is placed on a determined other side on the axis of the graph.

The observation device may be further equipped with the operation unit (36) that receives the operation of specifying the orientation concerning the magnitude, wherein the fourth storage control unit may cause the specified orientation concerning the magnitude to be stored in the storage unit. In accordance with this feature, the operator is capable of determining the orientation concerning the magnitude, as desired.

The display control unit may cause the display unit to display the graph, together with further displaying the current angle of rotation of the rotating body on the graph. In accordance with this feature, the convenience of the operator who performs the balance correcting operation is achieved.

The graph may include the angular axis (A_{RA}) representing, on the circle, the magnitude of the angle of rotation in the case that the positional deviation is zero, and the deviation axis (A_{PD}) representing the magnitude of the positional deviation, on the normal line to the circle. In accordance with this feature, the transition of the positional deviation accompanying the change in the angle of rotation can be shown to the operator in an easily understandable manner.

### Second Invention

The observation method for observing the balance state of the rotating body (16) of the machine tool (14), the machine tool including the rotating body, the detector (18) that detects the angle of rotation (RA) of the rotating body, and the moving body (20) which moves along the movement axis (X) perpendicular to the central line of rotation (L_{c}) of the rotating body, the observation method including the command output step (S1) of issuing the command to the machine tool so as to stop the moving body at the predetermined position while the rotating body is made to rotate, the first acquisition step (S2) of acquiring the angle of rotation, based on the detection signal of the detector, the second acquisition step (S3) of acquiring the positional deviation (PD) of the moving body in the direction of the movement axis, the first storage step (S4) of, at a time when the operating position at which the weight (28) for balance adjustment is actually attached to or detached from the rotating body is changed from the predetermined position (Pₒₚₑ) that is determined beforehand as the operating position at which the operator or the robot attaches or detaches the weight to or from the rotating body, storing in the storage unit (38) the first angular difference (AD₁) in the direction of rotation (D_{R}) of the rotating body between the predetermined operating position and the changed operating position (P′ₒₚₑ), the second storage step (S5) of storing in the storage unit the plurality of the angles of rotation and the positional deviations corresponding respectively to the plurality of the angles of rotation, in association with each other, the first compensation step (S6) of compensating the angle of rotation associated with the positional deviation or the current angle of rotation (RA) of the rotating body, on the basis of the first angular difference, and the display control step (S7) of causing the display unit (34) to display, based on the compensation result performed in the first compensation step, the graph showing the corresponding relationship between the plurality of the angles of rotation and the positional deviations that are stored in association with the plurality of the angles of rotation, together with causing the current angle of rotation (RA) of the rotating body to display on the graph.

In accordance with such features, the observation method is provided which is capable of observing the balance state of the rotating body of the machine tool, without using the field balancer, and further, which facilitates the balance correcting operation of the rotating body.

In the first storage step, there may further be stored the second angular difference (AD₂) in the direction of rotation of the rotating body between the installation position (P₁₈ₚᵣₑ), which is determined beforehand as a position where the detector is to be installed, and the position where the detector is actually installed (P₁₈), the observation method may further include the second compensation step of compensating the plurality of the angles of rotation, on the basis of the second angular difference, in the second storage step, the storage unit may be caused to store the plurality of the angles of rotation compensated in the second compensation step, and the positional deviations corresponding respectively to the plurality of the angles of rotation compensated in the second compensation step, in association with each other, and the graph displayed in the display control step may show a corresponding relationship between the plurality of the angles of rotation compensated in the second compensation step, and the positional deviations stored in association with the plurality of the angles of rotation compensated in the second compensation step. With this configuration, even if the detector is not installed at the predetermined installation position, the operator can easily perform the balance correcting operation of the rotating body.

The installation position and the predetermined operating position may be positions on a line (Lₓ) passing through the central line of rotation of the rotating body and parallel to the movement axis, and which sandwich the central line of rotation therebetween. In accordance with this feature, at the time when the positional deviation has become maximum in the first direction or the second direction, the installation position coincides with the unbalanced position of the rotating body in the direction of rotation.

The observation method may further include the input step of inputting the first angular difference, wherein, in the first storage step, the first angular difference that has been input is stored. In accordance with this feature, the operator is capable of specifying, as desired, the operating position after having been changed.

The moving body may be capable of moving along the movement axis in the first direction (+X), and the second direction (−X) opposite to the first direction, the observation method may further include the third storage step of storing the polarity concerning the first direction and the second direction, and in the display control step, the positional deviations may be displayed with a polarity in accordance with the polarity stored in the third storage step. In accordance with such features, even if the observation is carried out on a plurality of the machine tools the polarities of which are different, the operator can refer to the observation results with a unified polarity.

The observation method may further include the operation step of receiving the operation specifying the polarity, wherein, in the third storage step, the specified polarity may be stored. In accordance with this feature, the operator is capable of determining the polarity as desired.

The moving body may be capable of moving along the movement axis in the first direction (+X), and in the second direction (−X) opposite to the first direction, in the graph, the positional deviation that occurs in the first direction may be displayed with a positive polarity, and the positional deviation that occurs in the second direction may be displayed with a negative polarity, and the observation method may further include the fourth storage step of storing an orientation concerning the magnitude, of the axis (A_{PD}) indicating the magnitude of the positional deviation on the graph, and in the display control step, there may be determined the region of the positive polarity and the region of the negative polarity on the graph, in accordance with the orientation concerning the magnitude stored in the fourth storage step. In accordance with such features, irrespective of the manner in which the polarity of the machine tool is set, the polarity of the direction indicating the positive polarity in the observation device is placed on a determined one side on the axis of the graph. At the same time, the polarity of the direction indicating the direction of the negative polarity in the observation device is placed on a determined other side on the axis of the graph.

The observation method may further include the operation step of receiving the operation of specifying the orientation concerning the magnitude, wherein, in the fourth storage step, the specified orientation concerning the magnitude may be stored. In accordance with this feature, the operator is capable of determining the orientation concerning the magnitude, as desired.

The graph may include the angular axis (A_{RA}) representing, on the circle, the magnitude of the angle of rotation in the case that the positional deviation is zero, and the deviation axis (A_{PD}) representing the magnitude of the positional deviation, on the normal line to the circle. In accordance with this feature, the transition of the positional deviation accompanying the change in the angle of rotation (RA) can be shown to the operator in an easily understandable manner.

1. An observation device configured to observe a balance state of a rotating body of a machine tool, the machine tool including the rotating body, a detector configured to detect an angle of rotation of the rotating body, and a moving body configured to move along a movement axis perpendicular to a central line of rotation of the rotating body, the observation device comprising:
a command output unit configured to issue a command to the machine tool so as to stop the moving body at a predetermined position while the rotating body is made to rotate;
a first acquisition unit configured to acquire the angle of rotation, based on a detection signal of the detector;
a second acquisition unit configured to acquire a positional deviation of the moving body in a direction of the movement axis;
a first storage control unit configured to, at a time when an operating position at which a weight for balance adjustment is actually attached to or detached from the rotating body is changed from a predetermined position that is determined beforehand as an operating position at which an operator or a robot attaches or detaches the weight to or from the rotating body, cause a storage unit to store a first angular difference in a direction of rotation of the rotating body between the predetermined operating position and a changed operating position;
a second storage control unit configured to cause the storage unit to store a plurality of the angles of rotation and the positional deviation corresponding to each of the plurality of the angles of rotation, in association with each other;
a first compensation unit configured to compensate the angle of rotation associated with the positional deviation or a current angle of rotation of the rotating body, based on the first angular difference; and
a display control unit configured to cause a display unit to display, based on a compensation result of the first compensation unit, a graph showing a corresponding relationship between the plurality of the angles of rotation and the positional deviations that are stored in association with the plurality of the angles of rotation, and configured to further cause the current angle of rotation of the rotating body to be displayed on the graph.

2. The observation device according to claim 1, wherein:
the first storage control unit further causes the storage unit to store a second angular difference in the direction of rotation of the rotating body between an installation position that is determined beforehand as a position where the detector is to be installed, and a position where the detector is actually installed;
the observation device further comprises a second compensation unit configured to compensate the plurality of the angles of rotation, based on the second angular difference;
the second storage control unit causes the storage unit to store the plurality of the angles of rotation compensated by the second compensation unit, and the positional deviations corresponding respectively to the plurality of the angles of rotation compensated by the second compensation unit, in association with each other; and
the graph displayed by the display control unit shows a corresponding relationship between the plurality of the angles of rotation compensated by the second compensation unit, and the positional deviations stored in association with the plurality of the angles of rotation compensated by the second compensation unit.

3. The observation device according to claim 2, wherein the installation position and the predetermined operating position are positions on a line passing through the central line of rotation of the rotating body and parallel to the movement axis, and which sandwich the central line of rotation therebetween.

4. The observation device according to claim 1, further comprising:
an input unit configured to allow the operator to input the first angular difference;
wherein the first storage control unit causes the storage unit to store the first angular difference that has been input.

5. The observation device according to claim 1, wherein:
the moving body is movable along the movement axis in a first direction and a second direction opposite to the first direction;
the observation device further comprises a third storage control unit configured to cause the storage unit to store a polarity concerning the first direction and the second direction; and
the display control unit displays the positional deviations with a polarity in accordance with the polarity stored in the storage unit.

6. The observation device according to claim 5, further comprising:
an operation unit configured to receive an operation specifying the polarity;
wherein the third storage control unit causes the polarity that has been specified, to be stored in the storage unit.

7. The observation device according to claim 1, wherein:
the moving body is movable along the movement axis in a first direction and in a second direction opposite to the first direction;
in the graph, the positional deviation that occurs in the first direction is displayed with a positive polarity, and the positional deviation that occurs in the second direction is displayed with a negative polarity; and
the observation device further comprises a fourth storage control unit configured to cause the storage unit to store an orientation concerning a magnitude, of an axis indicating a magnitude of the positional deviation on the graph; and
the display control unit is configured to determine a region of the positive polarity and a region of the negative polarity on the graph, in accordance with the orientation concerning the magnitude stored in the storage unit.

8. The observation device according to claim 7, further comprising:
an operation unit configured to receive an operation specifying the orientation concerning the magnitude;
wherein the fourth storage control unit causes the orientation concerning the magnitude that has been specified, to be stored in the storage unit.

9. The observation device according to claim 1, wherein the graph includes an angular representing, on a circle, a magnitude of the angle of rotation in a case that the positional deviation is zero, and an deviation axis representing a magnitude of the positional deviation, on a normal line to the circle.

10. An observation method for observing a balance state of a rotating body of a machine tool, the machine tool including the rotating body, a detector configured to detect an angle of rotation of the rotating body, and a moving body configured to move along a movement axis perpendicular to a central line of rotation of the rotating body, the observation method comprising:
a command output step of issuing a command to the machine tool so as to stop the moving body at a predetermined position while the rotating body is made to rotate;
a first acquisition step of acquiring the angle of rotation, based on a detection signal of the detector;
a second acquisition step of acquiring a positional deviation of the moving body in a direction of the movement axis;
a first storage step of, at a time when an operating position at which a weight for balance adjustment is actually attached to or detached from the rotating body is changed from a predetermined position that is determined beforehand as an operating position at which an operator or a robot attaches or detaches the weight to or from the rotating body, storing in a storage unit a first angular difference in a direction of rotation of the rotating body between the predetermined operating position and a changed operating position;
a second storage step of storing in the storage unit a plurality of the angles of rotation and the positional deviation corresponding to each of the plurality of the angles of rotation, in association with each other;
a first compensation step of compensating the angle of rotation associated with the positional deviation or a current angle of rotation of the rotating body, based on the first angular difference; and
a display control step of causing a display unit to display, based on a compensation result performed in the first compensation step, a graph showing a corresponding relationship between the plurality of the angles of rotation and the positional deviations that are stored in association with the plurality of the angles of rotation, and further causing the current angle of rotation of the rotating body to be displayed on the graph.

11. The observation method according to claim 10, wherein:
in the first storage step, there is further stored a second angular difference in the direction of rotation of the rotating body between an installation position that is determined beforehand as a position where the detector is to be installed, and a position where the detector is actually installed;
the observation method further comprises a second compensation step of compensating the plurality of the angles of rotation, based on the second angular difference;
in the second storage step, the storage unit is caused to store the plurality of the angles of rotation compensated in the second compensation step, and the positional deviations corresponding respectively to the plurality of the angles of rotation compensated in the second compensation step, in association with each other; and
the graph displayed in the display control step shows a corresponding relationship between the plurality of the angles of rotation compensated in the second compensation step, and the positional deviations stored in association with the plurality of the angles of rotation compensated in the second compensation step.

12. The observation method according to claim 11, wherein the installation position and the predetermined operating position are positions on a line passing through the central line of rotation of the rotating body and parallel to the movement axis, and which sandwich the central line of rotation therebetween.

13. The observation method according to claim 10, further comprising:
an input step of inputting the first angular difference;
wherein, in the first storage step, the first angular difference that has been input is stored.

14. The observation method according to claim 10, wherein:
the moving body is movable along the movement axis in a first direction and a second direction opposite to the first direction;
the observation method further comprises a third storage step of storing a polarity concerning the first direction and the second direction; and
in the display control step, the positional deviations are displayed with a polarity in accordance with the polarity stored in the third storage step.

15. The observation method according to claim 14, further comprising:
an operation step of receiving an operation specifying the polarity;
wherein, in the third storage step, the polarity that has been specified is stored.

16. The observation method according to claim 10, wherein:
the moving body is movable along the movement axis in a first direction, and in a second direction opposite to the first direction;
in the graph, the positional deviation that occurs in the first direction is displayed with a positive polarity, and the positional deviation that occurs in the second direction is displayed with a negative polarity; and
the observation method further comprises a fourth storage step of storing an orientation concerning a magnitude, of an axis indicating a magnitude of the positional deviation on the graph; and
in the display control step, there is determined a region of the positive polarity and a region of the negative polarity on the graph, in accordance with the orientation concerning the magnitude stored in the fourth storage step.

17. The observation method according to claim 16, further comprising:
an operation step of receiving an operation specifying the orientation concerning the magnitude;
wherein, in the fourth storage step, the orientation concerning the magnitude that has been specified is stored.

18. The observation method according to claim 10, wherein the graph includes an angular axis representing, on a circle, a magnitude of the angle of rotation in a case that the positional deviation is zero, and an deviation axis representing a magnitude of the positional deviation, on a normal line to the circle.
